(19) United States
(12) Patent Application Publication
(10) Pub. No.: US 2026/0296273 A1
(43) Pub. Date: Oct. 1, 2026

(54) SEAT PLATE ADJUSTMENT SYSTEM AND CHILD SAFETY SEAT

(71) Applicant: Wonderland Switzerland AG, Steinhausen (CH)

(72) Inventors: Daliang ZHANG, Dongguan, Guangdong (CN); Jiajun LIANG, Dongguan, Guangdong (CN)

(73) Assignee: Wonderland Switzerland AG, Steinhausen (CH)

(21) Appl. No.: 19/478,601

(22) PCT Filed: Apr. 24, 2024
(86) PCT No.: PCT/EP2024/061244

§ 371 Date: Oct. 24, 2025

(30) Foreign Application Priority Data
Apr. 24, 2023 (CN) 202310457600.X
Apr. 24, 2023 (CN) 202310457619.4
May 9, 2023 (CN) 202310518024.5
May 12, 2023 (CN) 202310538266.0
Sep. 6, 2023 (CN) 202311149940.2

(51) Int. Cl. B60N 2/28; B60N 2/02

(52) U.S. Cl. CPC B60N 2/2812; B60N 2/0284

(57) ABSTRACT

A seat plate adjustment system for a child safety seat, includes a seat plate and a base, the seat plate being movable between a first position and a second position in a first direction relative to the base. The seat plate includes a first through hole configured to be thread by a crotch strap. The base comprises a second through hole configured to be threaded by the crotch strap. When the seat plate is at a first position, a length of the crotch strap passing through the first through hole is a first length; and when the seat plate is at a second position, a length of the crotch strap passing through the first through hole is a second length, and the first length being less than the second length.

### CROSS REFERENCE TO RELATED APPLICATION

This application is a U.S. national phase under 35 U.S.C. § 371 of International Application No. PCT/EP 2024/061244, filed on Apr. 24, 2024, and claims priority to Chinese Patent Application No. 202310457600X, entitled “ISOFIX SAFETY UNLOCK SYSTEM AND CHILD SAFETY SEAT”, filed on Apr. 24, 2023, Chinese Patent Application No. 2023104576194, entitled “SEAT PLATE ADJUSTMENT SYSTEM AND CHILD SAFETY SEAT”, filed on Apr. 24, 2023, Chinese Patent Application No. 2023105180245, entitled “ISOFIX SAFETY UNLOCK SYSTEM AND CHILD SAFETY SEAT”, filed on May 9, 2023, Chinese Patent Application No. 2023105382660, entitled “SEAT PLATE ADJUSTMENT SYSTEM AND CHILD SAFETY SEAT”, filed on May 12, 2023, and Chinese Patent Application No. 2023111499402, entitled “SEAT PLATE ADJUSTMENT SYSTEM AND CHILD SAFETY SEAT”, filed on Sep. 6, 2023, the entire contents of which are incorporated herein by reference.

### TECHNICAL FIELD

The present disclosure relates to the field of child safety seat technologies, and in particular, to a seat plate adjustment system and a child safety seat.

### BACKGROUND

To facilitate use and prolong a use cycle, child safety seats are generally designed to be suitable for children of a certain age. However, a vast majority of current child safety seats have a fixed seat length. The seats with the fixed length are difficult to adapt to children of various sizes, resulting in a decrease in comfort of the child safety seats.

In the case of a traffic accident, a backrest of the child safety seat may be pressed forward. In this case, parts (e.g., wing portions of the backrest) on two sides of the backrest that are in contact with a base (e.g., armrests on the base) may deform outwards in a transverse direction under a pressing force, that is, the two sides of the backrest may spread outwards, so that the base cannot continue to support the two sides of the backrest, causing the backrest to continue to press forward.

An ISOFIX fixing system is an internationally accepted connection system for a child safety seat. Generally, the ISOFIX fixing system includes an ISOFIX connector arranged on the child safety seat and an ISOFIX interface arranged on a vehicle seat. Connection and disassembly of the two are very convenient, bringing great convenience to users.

However, due to easy disassembly of the ISOFIX fixing system, the ISOFIX fixing system has safety hazards of easy accidental unlocking. In particular, in order to facilitate the users to operate the ISOFIX fixing system, an unlocking mechanism is generally arranged in an easily accessible position on the child safety seat, which further increases a possibility of accidental unlocking due to a mistaken touch. For example, the ISOFIX fixing system may be accidentally unlocked due to an accidental touch by a child in the child safety seat.

### SUMMARY

Based on this, there is a need to provide a seat plate adjustment system, an ISOFIX safety unlock system, and a child safety seat with respect to the above problems. The seat plate adjustment system and the child safety seat can adjust a seat length of the child safety seat in a simple manner to adapt to use requirements of children of various sizes. The ISOFIX safety unlock system and the child safety seat can, on the one hand, retain easy disassembly of the ISOFIX fixing system, and on the other hand, can also prevent accidental unlocking caused by a mistaken touch.

In order to achieve the above objective, according to an aspect of the present disclosure, embodiments of the present disclosure provide a seat plate adjustment system for a child safety seat. The seat plate adjustment system comprises a seat plate and a base, the seat plate is movable between a first position and a second position in a first direction relative to the base. The seat plate further comprises: an adjustment portion operable to restrict movement of the seat plate in the first direction relative to the base; a connecting portion restricting movement of the seat plate in a second direction relative to the base, the second direction being perpendicular to the first direction; and a first through hole configured to be thread by a crotch strap. The base comprises a second through hole configured to be threaded by the crotch strap. When the seat plate is at a first position, a projection of the second through hole in a vertical direction does not overlap with a projection of the first through hole in the vertical direction, a length of the crotch strap passing through the first through hole is a first length; and when the seat plate is at a second position, at least part of the projection of the second through hole in the vertical direction overlaps with the projection of the first through hole in the vertical direction, a length of the crotch strap passing through the first through hole is a second length, and the first length being less than the second length. A gap is formed between a side of a front end of the base facing the seat plate and a side of a front end of the seat plate facing the base, the gap being adapted to allow the crotch strap to pass through.

According to another aspect of the present disclosure, the embodiments of the present disclosure further provide a child safety seat comprising: a base provided with an armrest; and a backrest. A side of the armrest facing the backrest is provided with a first surface, a side of the backrest facing the armrest is provided with a second surface, the first surface and the second surface are arranged opposite to each other, and at least one of the first surface and the second surface is provided with a limiting mechanism. The limiting mechanism is configured such that when the first surface contacts the second surface, the limiting mechanism provides resistance to prevent transverse sliding of the second surface relative to the first surface. The backrest is provided with a wing portion, the second surface is arranged at the wing portion, there is a gap between the wing portion and the armrest, and the first surface and the second surface are located on two sides of the gap respectively.

According to another aspect of the present disclosure, the embodiments of the present disclosure further provide an International Standards Organization FIX (ISOFIX) safety unlock system for a child safety seat, the ISOFIX safety unlock system comprising: an ISOFIX connector switchable between a locked state and an unlocked state; a first unlocking apparatus operably connected to the ISOFIX connector, the first unlocking apparatus comprising a first unlocking operating portion, the first unlocking operating portion being slidable between a lock position and an unlock position, and when the first unlocking operating portion switches from the lock position to the unlock position, the first unlocking apparatus switches the ISOFIX connector from the locked state to the unlocked state; and a second unlocking apparatus operably connected to the first unlocking apparatus, the second unlocking apparatus comprising a second unlocking operating portion, the second unlocking operating portion being slidable between a safe position and a free position, and when the second unlocking operating portion is at the safe position, the second unlocking apparatus locks the first unlocking operating portion to the lock position. The first unlocking apparatus comprises a first joint portion and a second joint portion that are connected to the first unlocking operating portion. The second unlocking apparatus comprises a third joint portion. When the first unlocking operating portion is at the lock position and the second unlocking operating portion is at the safe position, the third joint portion fits the first joint portion to lock the first unlocking operating portion to the lock position; and when the first unlocking operating portion is at the unlock position and the second unlocking apparatus is at the free position, the third joint portion fits the second joint portion to lock the first unlocking operating portion to the unlock position. A sliding direction of the first unlocking operating portion is not parallel to a sliding direction of the second unlocking operating portion.

According to the ISOFIX safety unlock system, the second unlocking operating portion has to be adjusted to the free position before the first unlocking operating portion can be slid to the unlock position to prevent accidental unlocking caused by a random touch of the child on the first unlocking operating portion.

### BRIEF DESCRIPTION OF THE DRAWINGS

The above and other objectives, features, and advantages of the present disclosure will become clearer through a more specific description of preferred embodiments of the present disclosure as shown in the accompanying drawings. Throughout the drawings, same reference numerals denote same parts, and the drawings are not deliberately drawn to scale to actual sizes. The key point is to illustrate the gist of the present disclosure.

Other features, objects and advantages of the present disclosure will become more apparent by reading a detailed description of the non-limiting embodiments with reference to the following drawings:

FIG. 1 is a schematic perspective view of a child safety seat according to an embodiment of the present disclosure, in which a seat plate is at a first position;

FIG. 2 is a schematic side view of the child safety seat according to an embodiment of the present disclosure, in which the seat plate is at the first position;

FIG. 3 is a schematic side view of the child safety seat according to an embodiment of the present disclosure, in which the seat plate is at a second position;

FIG. 4A is a schematic structural diagram of the seat plate according to an embodiment of the present disclosure;

FIG. 4B is a schematic structural diagram of the seat plate according to an embodiment of the present disclosure;

FIG. 5 is a schematic perspective view of the child safety seat according to an embodiment of the present disclosure, in which the seat plate is omitted;

FIG. 6 is a schematic top view of the child safety seat according to an embodiment of the present disclosure, in which the seat plate is at the second position;

FIG. 7 is a sectional view taken along a line B-B in FIG. 6;

FIG. 8 is a sectional view taken along a line A-A in FIG. 6;

FIG. 9 is a schematic perspective view of the child safety seat according to an embodiment of the present disclosure, in which the seat plate is at the second position;

FIG. 10 is a schematic side view of the child safety seat according to an embodiment of the present disclosure, in which the seat plate is at the second position;

FIG. 11 is a schematic side view of the child safety seat according to an embodiment of the present disclosure, in which the seat plate is at the first position;

FIG. 12 is a schematic structural diagram of the seat plate according to an embodiment of the present disclosure;

FIG. 13 is a schematic perspective view of the child safety seat according to an embodiment of the present disclosure, in which the seat plate is omitted;

FIG. 14 is a schematic structural diagram of the seat plate according to an embodiment of the present disclosure, in which a side of the seat plate away from a base is removed;

FIG. 15 is a schematic sectional view taken along a line C-C in FIG. 13, in which a backrest structure is partially omitted;

FIG. 16A is a schematic sectional view taken along a line D-D in FIG. 13, in which the backrest structure is partially omitted;

FIG. 16B is a schematic enlarged view of a part of a safety belt in FIG. 16A;

FIG. 17A is a schematic diagram of sliding of the seat plate shown in FIG. 16A into the second position;

FIG. 17B is a schematic enlarged view of a part of a safety belt in FIG. 17A;

FIG. 18 is a schematic partial exploded view of the child safety seat according to an embodiment of the present disclosure;

FIG. 19 is a schematic side view of the child safety seat according to an embodiment of the present disclosure;

FIG. 20 is a schematic structural diagram of a seat plate and a base of the child safety seat according to an embodiment of the present disclosure;

FIG. 21 is a perspective view of a child safety seat according to an embodiment of the present disclosure;

FIG. 22 is a side view of the child safety seat in FIG. 21;

FIG. 23 is an enlarged view of Part E in FIG. 22;

FIG. 24 shows a base of the child safety seat according to an embodiment of the present disclosure;

FIG. 25 shows a backrest of the child safety seat according to the shown in FIG. 24;

FIG. 26 shows a base of the child safety seat according to an embodiment of the present disclosure;

FIG. 27 shows a backrest of the child safety seat according to the shown in FIG. 26;

FIG. 28 shows a base of the child safety seat according to an embodiment of the present disclosure;

FIG. 29 shows a backrest of the child safety seat according to the shown in FIG. 28;

FIG. 30 shows a base of the child safety seat according to an embodiment of the present disclosure;

FIG. 31 shows a backrest of the child safety seat according to the shown in FIG. 30;

FIG. 32 is a perspective view of a child safety seat according to an embodiment of the present disclosure, in which a first unlocking operating portion is at a lock position and a second unlocking operating portion is at a safe position;

FIG. 33 is a partial enlarged view of Region F in FIG. 32;

FIG. 34 is a sectional view taken along a line G-G in FIG. 32;

FIG. 35 is a partial enlarged view of Region H in FIG. 34;

FIG. 36 is a three-dimensional perspective view of the child safety seat according to an embodiment of the present disclosure, in which the first unlocking operating portion is at the lock position and the second unlocking operating portion is at a free position;

FIG. 37 is a partial enlarged view of Region I in FIG. 36;

FIG. 38 is a sectional view taken along a line J-J in FIG. 36;

FIG. 39 is a partial enlarged view of Region K in FIG. 38;

FIG. 40 is a three-dimensional perspective view of the child safety seat according to an embodiment of the present disclosure, in which the first unlocking operating portion is at an unlock position and the second unlocking operating portion is at the free position;

FIG. 41 is a partial enlarged view of Region L in FIG. 40;

FIG. 42 is a sectional view taken along a line M-M in FIG. 40;

FIG. 43 is a partial enlarged view of Region N in FIG. 42;

FIG. 44 is a partial exploded view of a child safety seat according to an embodiment of the present disclosure;

FIG. 45 is a three-dimensional exploded view of an ISOFIX connector in FIG. 44;

FIG. 46 is a three-dimensional view of an ISOFIX safety unlock system according to an embodiment of the present disclosure;

FIG. 47 is a sectional view taken along a line O-O in FIG. 46, in which the first unlocking operating portion is at the lock position;

FIG. 48 is a sectional view taken along a line P-P in FIG. 46, in which the ISOFIX connector is in a locked state;

FIG. 49 is a sectional view taken along the line O-O in FIG. 46, in which the first unlocking operating portion is at the unlock position; and

FIG. 50 is a sectional view taken along the line P-P in FIG. 46, in which the ISOFIX connector is in an unlocked state.

### LIST OF REFERENCE SIGNS

1 child safety seat, 10 seat plate adjustment system, 20 backrest
100 seat plate, 101 first connecting portion, 102 first adjustment portion, 103, 103′ first through hole, 104 third concave portion, 105 fourth through hole
110 base, 111 second connecting portion, 112 second adjustment portion, 113 third adjustment portion, 114 second through hole, 115 receiving groove, 116 first concave portion, 117 fourth concave portion, 118 locking member
120 gap
1011 first stopper, 1012 first elastic member, 1013 screw
200 seat plate, 201 first connecting portion, 202 first adjustment portion
210 base, 211 second connecting portion, 212 second adjustment portion, 213 third adjustment portion
220 lower plate, 230 first accommodating space, 240 second accommodating space, 250 upper plate
2001 first through hole, 2011 second stopper, 2021 operating member, 2022 first connecting member, 2023 first engaging member, 2024 third elastic member, 2101 second through hole, 2102 first concave portion, 2111 through groove, 2201 second concave portion, 2202 opening, 2203 limiting convex portion, 2204 first accommodating groove, 2205 second accommodating groove, 2206 third through hole
20111 second screw, 20112 second gasket, 20211 limiting groove
300 engaging groove, 310 connecting rod, 320 reinforcing tube
400 engaging portion, 401 lock tongue, 410 hook portion
4011 curved portion
500 safety belt
D1 front direction
D2 rear direction
d1 length of the safety belt passing through the first through hole
d2 length of a folded portion of the safety belt
d3 length of the safety belt passing through the first through hole
L1 height of an upper edge of the second through hole in a vertical direction
L2 height of an upper edge of the first through hole in the vertical direction
6 child safety seat
61 base, 610 armrest, 611 first surface
62 backrest, 620 wing portion, 621 second surface
630 limiting mechanism, 631 positioning recess, 632 first positioning protrusion, 633 second positioning protrusion, 634 third positioning protrusion, 635 friction member, 636 limiting rib
7 child safety seat,
700 ISOFIX safety unlock system, 710 first unlocking apparatus, 711 fixed seat, 712 first unlocking operating portion, 713 first driving member
7110 third accommodating space, 7111 observation window, 7112 second guide member, 7133 pivot shaft, 7120 first joint portion, 7121 first pressing portion, 7122 color indicator, 7123 pivot space, 7124 first guide member, 7125 second joint portion, 7131 first arm, 7132 second arm
71251 step surface
720 ISOFIX connector
7201 housing, 7202 bracket, 7203 second driving member, 7204 second engaging member, 7205 hook, 7206 limiting member, 7207 sixth elastic member, 7208 seventh elastic member
72021 second sliding groove, 72032 third surface, 72051 boss, 72052 first surface, 72053 second surface, 72054 pin shaft
730 second unlocking apparatus, 732 fifth elastic member
7310 third joint portion, 7311 second unlocking operating portion, 7312 limiting space
73101 chamfered surface
740 second connecting member

### DETAILED DESCRIPTION

In order to facilitate understanding of the present disclosure, the present disclosure will be described more fully below with reference to the relevant drawings. Preferred embodiments of the present disclosure are given in the drawings. However, the present disclosure may be implemented in many different forms and is not limited to the embodiments described herein. Rather, these embodiments are provided to make the contents disclosed in the present disclosure more fully understood.

It is to be noted that, when one element is considered to be “connected to” another element, it may be directly connected to and integrated with the another element or an intermediate element may co-exist. The terms “mount”, “one end”, “the other end” and similar expressions used herein are for illustrative purposes only.

It is to be noted that, in the description of the present disclosure, the orientation or position relationships indicated by the terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, and the like are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

Unless defined otherwise, all technical and scientific terms used herein have the same meanings as would generally understood by those skilled in the technical field of the present disclosure. The terms used herein in the specification of the present disclosure are for the purpose of describing specific embodiments only, and are not intended to limit the present disclosure. The term “and/or” used herein includes any and all combinations of one or more related listed items.

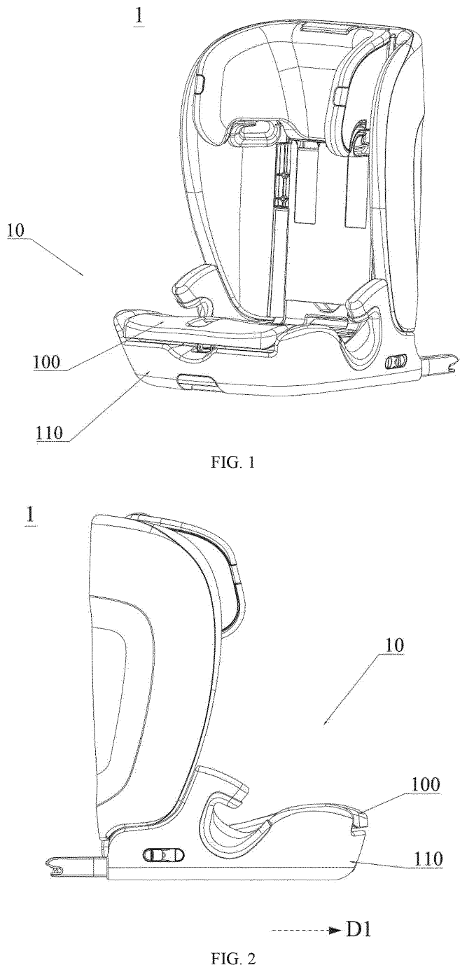

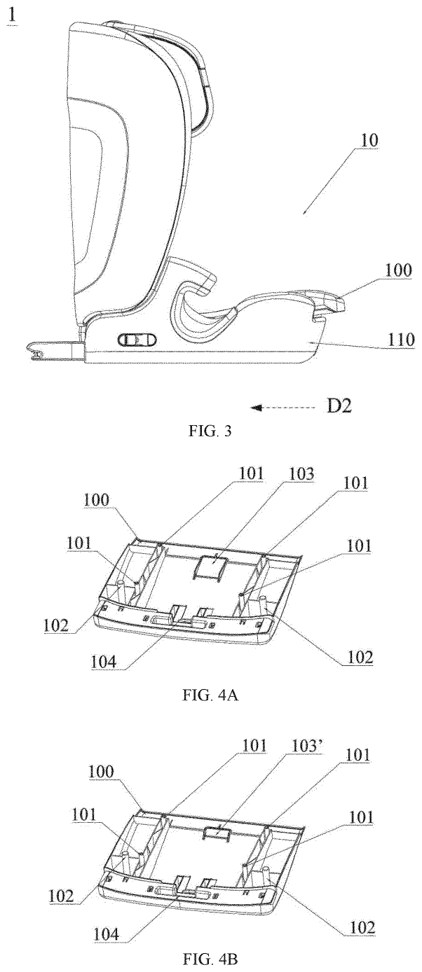

Referring to FIG. 1 to FIG. 3, in an embodiment of the present disclosure, a child safety seat 1 includes a seat plate adjustment system 10. The seat plate adjustment system 10 includes a seat plate 100 and a base 110. The seat plate 100 is slidably connected to an upper surface of the base 110, and the seat plate 100 is slidable between a first position and a second position relative to the base 110. Referring to FIG. 2 and FIG. 3 together, in the child safety seat 1 shown in FIG. 2, the seat plate 100 is at the first position. In this case, the child safety seat 1 has a shorter total seat cushion length and is suitable for riding by young children, for example, 3 to 5 years old. The seat plate 100 shown in FIG. 2 slides forward along a direction D1 to enter the second position (as shown in FIG. 3). In this case, the child safety seat 1 has a longer total seat cushion length and is suitable for riding by young children, for example, 6 to 12 years old. Similarly, the seat plate 100 shown in FIG. 3 slides backward along a direction D2 opposite to the direction D1 to enter the first position (as shown in FIG. 2). In the present disclosure, the direction D1 is defined as a “front” direction, and the direction D2 as a “rear” direction. The “front” mentioned hereinafter is the direction D1, and the “rear” is the direction D2. A direction perpendicular to both a sliding direction and a vertical direction is a traverse direction. When the seat plate 100 is at the first position, a front end of the seat plate is roughly flush with a front end of the base. When the seat plate 100 is at the second position, the front end of the seat plate extends from the front end of the base. Therefore, a seat length of the child safety seat 1 when the seat plate 100 is at the first position is less than that of the child safety seat 1 when the seat plate 100 is at the second position.

Referring to FIG. 4A and FIG. 5, FIG. 4A is a schematic structural diagram of the seat plate according to an embodiment of the present disclosure, and FIG. 5 is a schematic perspective view of the child safety seat according to an embodiment of the present disclosure, in which the seat plate is at the first position. In the embodiment shown in FIG. 4A, the seat plate 100 is provided with at least one first connecting portion 101. Specifically, in this embodiment, 4 first connecting portions 101 are provided. Optionally, more or fewer than 4 first connecting portions may be provided, for example, 3 or 6. The number of the first connecting portion may be reasonably selected according to an actual requirement, which is not limited in the present disclosure. Specifically, the first connecting portion 101 is a connecting column fixedly arranged on a side of the seat plate 100 facing the base 110. In the embodiment shown in FIG. 5, the base 110 is provided with at least one second connecting portion 111 fitting the first connecting portion 101, and the seat plate 100 is slidably connected to the base 110 through the fitting between the first connecting portion 101 and the second connecting portion 111. Specifically, in this embodiment, 4 second connecting portions 111 are provided. Optionally, more or fewer than 4 second connecting portions may be provided, for example, 3 or 6. The number of the second connecting portion matches the number of the first connecting portion. Specifically, the second connecting portion 111 is a first connecting groove arranged on a side of the base 110 facing the seat plate 100. The first connecting groove extends in a front-rear direction of the seat. The connecting column is inserted into the first connecting groove and plays a guiding role, enabling the seat plate 100 to slide forward and backward along a length direction of the first connecting groove and also preventing transverse movement and shift of the seat plate 100.

Still referring to FIG. 4A and FIG. 5, in the embodiment shown in FIG. 4A, the seat plate 100 is provided with at least one first adjustment portion 102. Specifically, in this embodiment, 2 first adjustment portions 102 are provided. Optionally, more or fewer than 2 first adjustment portions may be provided, for example, 1 or 4. The number of the first adjustment portion may be reasonably selected according to an actual requirement, which is not limited in the present disclosure. Specifically, the first adjustment portion 102 is an adjustment column fixedly arranged on the side of the seat plate 100 facing the base 110. In the embodiment shown in FIG. 5, the base 110 is provided with a second adjustment portion 112 and a third adjustment portion 113 that fit the first adjustment portion 102. Specifically, 2 second adjustment portions 112 and 2 third adjustment portions 113 are provided. Optionally, more or fewer second adjustment portions and third adjustment portions may be provided, and numbers of the second adjustment portion and the third adjustment portion match the number of the first connecting portion. Specifically, the second adjustment portion 112 is a first adjustment hole arranged on the side of the base 110 facing the seat plate 100, and the third adjustment portion 113 is a second adjustment hole arranged on the side of the base 110 facing the seat plate 100. The first adjustment hole is positioned such that when the seat plate 100 slides to the first position, the adjustment column can be inserted into the first adjustment hole to fix the seat plate 100 to the first position. If the seat plate 100 is unfixed from the first position, there is a need to lift the seat plate 100 upwards to detach the adjustment column from the first adjustment hole, and then the seat plate is unfixed. The second adjustment hole is positioned such that when the seat plate 100 slides to the second position, the adjustment column can be inserted into the second adjustment hole to fix the seat plate 100 to the second position. Similarly, if the seat plate 100 is unfixed from the first position, there is a need to lift the seat plate 100 upwards to detach the adjustment column from the second adjustment hole, and then the seat plate is unfixed. Those skilled in the art may understand that the arrangement of the first adjustment hole and the second adjustment hole is only exemplary and may be determined according to a usage requirement, and additional adjustment holes may also be arranged, such as a third adjustment hole and a fourth adjustment hole, to fix the seat plate 100 to more positions, such as a third position and a fourth position, which is not specifically limited in the present disclosure. In the embodiments shown in FIG. 4A and FIG. 5, the seat plate 100 may be unfixed from the first position or the second position only by simply lifting the seat plate 100, so as to slide the seat plate 100 and change the seat length, which is convenient to operate and easy to use. A length of the first adjustment portion 102 is less than that of the first connecting portion 101. The seat plate 100 is lifted upwards until the first stopper 1011 abuts against a lower surface of an upper plate of the base 110 and the first adjustment portion 102 is completely detached from the second adjustment portion 112 or the third adjustment portion 113. Therefore, the first connecting portion 101 and the second connecting portion 111 can move relatively in the vertical direction without detachment, so that the first adjustment portion 102 unfits the second adjustment portion 112 or the third adjustment portion 113. In some embodiments, the first adjustment portion 102 may alternatively be one or more sets of anti-skid ribs extending transversely, the second adjustment portion 112 may be anti-skid grooves matching shapes of the anti-skid ribs, and the anti-skid grooves are distributed along a front-rear direction on the upper surface of the base 110, whose number is greater than that of the anti-skid ribs. The anti-skid ribs fit the anti-skid grooves, which can prevent movement of the seat plate 100 in the front-rear direction relative to the base 110. When the anti-skid ribs fit part of the anti-slip grooves near the back, the seat plate 100 is at the first position. In this case, the child safety seat 1 is suitable for riding by a smaller child. When the anti-skid ribs fit part of the anti-slip grooves near the front, the seat plate 100 is at the second position. In this case, the child safety seat 1 is suitable for riding by a larger child.

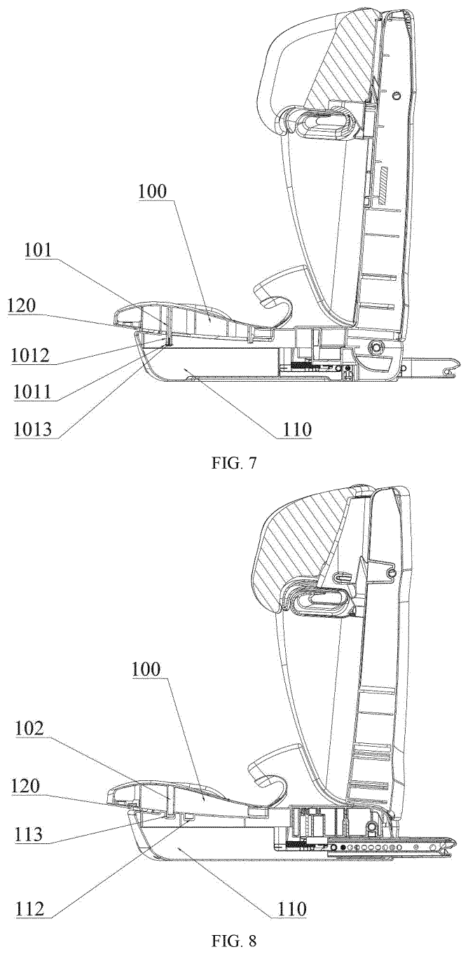

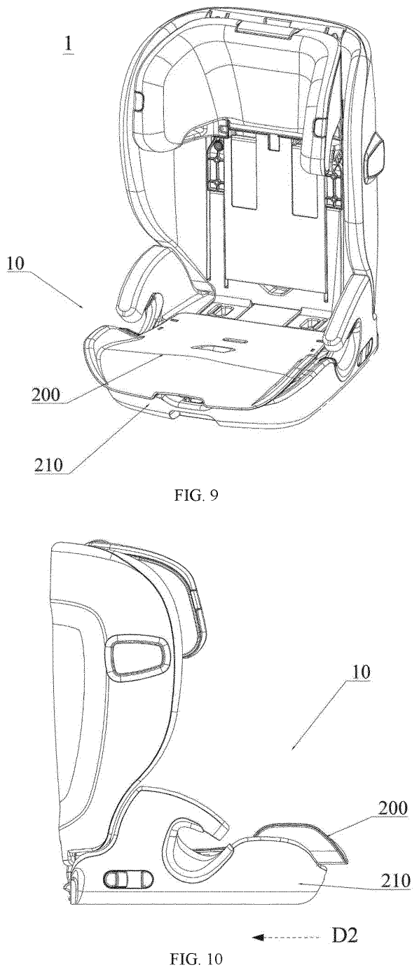

Referring to FIG. 7 and FIG. 8, the upper surface of the base 110 has a bevel, and a height of the bevel gradually decreases from the front end of the base 110 towards the backrest. For example, an average slope of the bevel relative to a horizontal plane is about 10 degrees. When the seat plate 100 fits the upper surface of the base 110, a front edge of the seat plate 100 is tilted, so that a user can lift the seat plate 100 from the front edge. On the other hand, the upper surface has a higher slope near the front end of the base 110 and a lower slope near the front end of the base 110. In other words, the upper surface of the base 110 is slightly concave in the front-rear direction. The second adjustment portion 112 is closer to the backrest than the third adjustment portion 113 in the front-rear direction, and the second adjustment portion 112 and the third adjustment portion 113 extend in the vertical direction. Therefore, the second adjustment portion 112 and the third adjustment portion 113 are at an angle of 5 to 15 degrees with the upper surface of the base 110. Correspondingly, the first connecting portion 101 and the first adjustment portion 102 also extend in the vertical direction and are at a certain angle with the seat plate 100. In some other embodiments, the second adjustment portion 112 and the third adjustment portion 113 are at different angles with the upper surface of the base 110 respectively. For example, the second adjustment portion 112 is at an angle of 85 degrees with the upper surface of the base 110, and the third adjustment portion 113 is at an angle of 80 degrees with the upper surface of the base 110. Therefore, when the first adjustment portion 102 located at the front edge of the seat plate 100 is snap-fit with the third adjustment portion 113 (at the second position), a rear edge of the seat plate 100 exerts a greater pressing force on a contact surface with the base 110, thereby preventing tilting of the rear edge of the seat plate 100. The second adjustment portion 112 and the third adjustment portion 113 have different heights. Specifically, a height of the bottom of the second adjustment portion 112 in the vertical direction is lower than the height of the third adjustment portion 113 in the vertical direction, or a height of an upper edge of the second adjustment portion 112 in the vertical direction is lower than the height of the third adjustment portion 113 in the vertical direction. The height of the seat plate 100 in the vertical direction when the first adjustment portion 102 of the seat plate 100 is inserted into the second adjustment portion 112 (i.e., the seat plate 100 is at the first position) is lower than the height of the seat plate 100 when the first adjustment portion 102 of the seat plate 100 is inserted into the third adjustment portion 113 (i.e., the seat plate 100 is at the second position). The first adjustment portion 102 is located on a front side (e.g., at the front edge) of the seat plate 100 in the front-rear direction. Front and rear sides of the seat plate 100 are each provided with the first connecting portion 101. For example, 2 first connecting portions 101 are located at the front edge of the seat plate 100 in the front-rear direction, and the 2 first connecting portions 101 are located at the rear edge of the seat plate 100 in the front-rear direction. A length of the first connecting portion 101 located at the front edge is greater than that of the first connecting portion 101 located at the rear edge. For example, the first connecting portion 101 at the front edge may move in the vertical direction and the front-rear direction at the same time relative to the second connecting portion 111; and the first connecting portion 101 at the rear edge cannot move in the vertical direction relative to the second connecting portion 111, but can only move in the front-rear direction. The seat plate 100 is made of an elastic material such as rubber or thermoplastic rubber (TPR). When the user uses a third concave portion 104 on the front edge of the seat plate 100 to lift the seat plate 100, the seat plate 100 may deform. Specifically, referring to FIG. 10 and FIG. 11, on the basis of the child safety seat 1 shown in FIG. 10, when the user uses the third concave portion 104 on the front edge of the seat plate 100 to lift the seat plate 100, the front edge of the seat plate 100 is detached from the base 110 in the vertical direction, so that the first adjustment portion 102 is detached from the third adjustment portion 113. A flat portion of the rear edge of the seat plate 100 is still attached to the base 110 under fixation of the first connecting member 101 arranged at the back, so the middle of the seat plate 100 deforms concavely towards one side of the base 110. Therefore, the user can push the seat plate 100 to slide back and forth on the base 110 without lifting the entire seat plate 100 away from the base 110, ensuring stability of the sliding. The user pushes the seat plate 100 along the direction D2, so that the seat plate 100 slides on the base 110 towards the backrest. When the seat plate 100 slides to the position shown in FIG. 11, the user stops exerting a force along D2 and a vertical upward force. In this case, the seat plate 100 returns to a state before deformation under the action of elastic potential energy, and the first adjustment portion 102 is vertically inserted into the second adjustment portion 112 to lock the base 110 to the first position. In some embodiments, the seat plate 100 may be made of a rigid material such as polyphenylene sulfide (PPS). A length of the first connecting portion 101 near the front end of the seat plate 100 is greater than that of the first connecting portion 101 near the rear end of the seat plate 100. When the user uses the third recess 104 on the front edge of the seat plate 101 to lift the seat plate 100, the front edge of the seat plate 100 is detached from the base 110 in the vertical direction, and under a connection effect of a plurality of first connecting portions 101 of different lengths, the rear edge of the seat plate 100 pivots relative to the base 110.

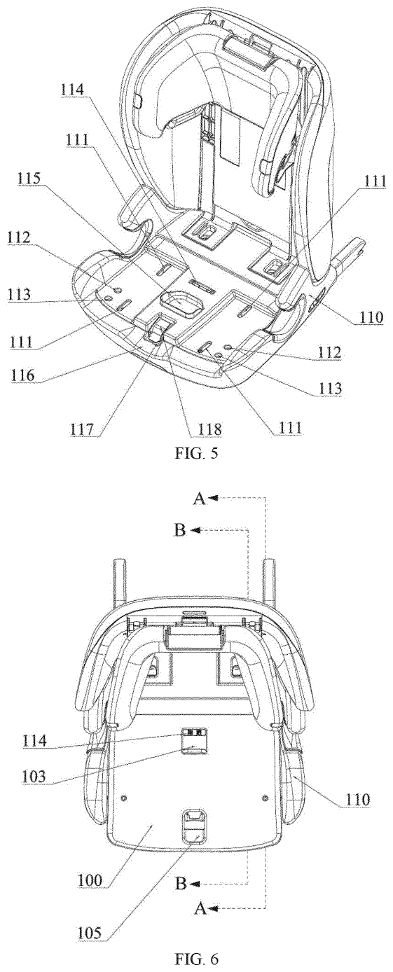

Still referring to FIG. 4A and FIG. 5, in this embodiment, the seat plate 100 further includes a first through hole 103 configured to be thread by a safety belt (a crotch strap), and the base 110 further includes a second through hole 114 configured to be thread by the crotch strap. A length of the first through hole 103 in the sliding direction is greater than that of the second through hole 114 in the sliding direction, and in a sliding stroke of the seat plate 100 from the first position to the second position, a projection of the second through hole 114 in the vertical direction is always located within a projection of the first through hole 103 in the vertical direction (refer to FIG. 6). Therefore, during the sliding of the seat plate 100 between the first position and the second position, the first through hole 103 and the second through hole 114 always have a partially overlapping region in the vertical direction, which may not lead to an influence on a length of the crotch strap due to bending when the crotch strap passes through the first through hole 103 and the second through hole 114.

In other embodiments, referring to FIG. 4B, in the embodiment shown in FIG. 4B, extension of the first through hole 103′ in the front-rear direction is less than or equal to extension of the first through hole 103 in the front-rear direction shown in FIG. 4A. When the seat plate 100 is at the first position, a projection of the second through hole 114 in the vertical direction does not overlap with a projection of the first through hole 103 in the vertical direction. When the seat plate 100 is at the second position, at least part of the projection of the second through hole 114 in the vertical direction overlaps with the projection of the first through hole 103′ in the vertical direction. A second accommodating space (not shown) adapted to accommodate a safety belt is formed between the seat plate 100 and the base 110. Therefore, when the seat plate 100 is at the first position, the safety belt passing through the first through hole 103′ and the second through hole 114 may be folded, and part of the safety belt may be in the second accommodating space. Therefore, a length of the safety belt passing through the first through hole 103′ is less than that of the safety belt passing through the first through hole 103. When the seat plate 100 is at the second position, the first through hole 103′ and the second through hole 114 are aligned in the vertical direction, and the safety belt passing through the first through hole 103′ and the second through hole 114 is not folded. Therefore, a length of the safety belt passing through the first through hole 103′ when the seat plate 100 is at the second position is greater than a length of the safety belt passing through the first through hole 103 when the seat plate 100 is at the first position. When the seat plate 100 is at the first position, the seat is shorter and suitable for a smaller child, and the safety belt for a smaller child is also shorter. When the seat plate 100 is at the second position, the seat is longer and suitable for a larger child, and the safety belt for a larger child is also longer. In addition, when the seat plate 100 slides from the first position to the second position, the position of the first through hole 103′ also moves forward, driving a position of the safety belt to move forward, thereby leaving more riding space for a crotch of a larger children in the front-rear direction. Therefore, the first through hole 103′ shown in FIG. 4B can reduce a workload of shortening the safety belt and improve ease of use of the child safety seat. This will be explained further below.

Referring to FIG. 5 and FIG. 6, in an embodiment of the present disclosure, the base 110 is further provided with a fourth concave portion 117. The fourth concave portion 117 is adapted to be passed through by a safety belt adjustment strap. A locking member 118 is further arranged in the fourth concave portion 117. The locking member 118 is configured to allow only one-way sliding of the safety belt adjustment strap. Specifically, the safety belt of the child safety seat (e.g., a shoulder strap, a crotch strap, or a waist strap) includes a used part and a free part. The used part is exposed outside the child safety seat, for example, outside the backrest 20 or the seat plate 100. A buckle (such as a five-point buckle) is slidably arranged on the used part. A child is secured to the child safety seat through the used part of the safety belt and the buckle. The free part is arranged inside the child safety seat, for example, inside the backrest 20 or between the seat plate 100 and the base 110. The free part of the safety belt is connected with the safety belt adjustment strap. By pulling the safety belt adjustment strap, the user can reduce the length of the used part of the safety belt, so that the safety belt can fit children of different sizes. The locking member 118 may switch between a locked state and an unlocked state. The locking member 118 includes a reset member. The reset member constantly causes the locking member 118 to have a tendency to return to the locked state and maintain the locking member 118 in the locked state. In the locked state, the locking member 118 only allows the safety belt adjustment strap to slide in a direction where the length of the used part is reduced. In the unlocked state, the locking member 118 does not restrict the sliding of the safety belt adjustment strap. The safety belt adjustment strap passes through the fourth concave portion 117 so that at least part of the safety belt adjustment strap reaches from interior of the child safety seat to exterior of the child safety seat. The user pulls the safety belt adjustment strap to reduce the length of the used part of the safety belt. In this embodiment, the safety belt adjustment strap is connected to the shoulder strap. Optionally, the safety belt adjustment strap may alternatively be connected to another safety belt, such as the crotch strap or the waist strap. In an embodiment of the present disclosure, the seat plate 100 is further provided with a fourth through hole 105. Optionally, in a sliding stroke of the seat plate 100 from the first position to the second position, a projection of the fourth through hole 105 in a vertical direction at least partially overlaps with a projection of the fourth concave portion 117 in the vertical direction. After passing through the fourth concave portion 117, the safety belt adjustment strap may continue to pass through the fourth through hole 105 to be exposed to the outside of the seat plate 100 to facilitate the user to operate the safety belt adjustment strap. Optionally, the fourth through hole 105 allows the user to contact and operate the locking member 118 to switch the locking member 118 from the locked state to the unlocked state.

Referring to FIG. 6 to FIG. 8, FIG. 6 is a schematic top view of the child safety seat according to an embodiment of the present disclosure, in which the seat plate 100 is at the second position; FIG. 7 is a sectional view taken along a line B-B in FIG. 6; and FIG. 8 is a sectional view taken along a line A-A in FIG. 6. As shown in FIG. 7, an end of the first connecting portion 101, for example, the connecting column, away from the seat plate 100 is provided with a first stopper 1011. The first stopper 1011 is detachably fixed to an end of the connecting column away from the seat plate 100, and the first stopper 1011 is sized so as not to pass through the first connecting groove. Specifically, in this embodiment, the first stopper 1011 is a gasket, and the gasket is fixed to the end of the connecting column away from the seat plate 100 through a screw 1013. A diameter of the gasket is greater than a horizontal width of the second connecting portion 111, for example, the first connecting groove. Therefore, the gasket cannot pass through the first connecting groove. When the seat plate 100 is lifted upwards and the gasket abuts against a back surface of the side of the base 110 facing the seat plate 100, the seat plate may be restricted and cannot continue to rise. Through the arrangement of the gasket, a bottom surface of the seat plate may be allowed to be out of contact with a top surface of the base, and thorough disconnection of the seat plate from the base due to upward lifting is prevented at the same time. In this embodiment, a length of the connecting column passing through the first connecting groove is greater than a depth of the adjustment column inserted into the first adjustment hole or the second adjustment hole (refer to FIG. 8). Therefore, detachment of the adjustment column from the first adjustment hole or the second adjustment hole is allowed while the disconnection of the seat plate from the base due to upward lifting is prevented. Those skilled in the art should understand that the gasket is only an example, and the first stopper 1011 may alternatively be another suitable mechanism, such as a thumb screw, which is not limited in the present disclosure.

Still referring to FIG. 7, in the embodiment shown in FIG. 7, a first elastic member 1012 is arranged around the connecting column, one end of the first elastic member 1012 abuts against a back surface of a side of the base 110 facing the seat plate 100, the other end of the first elastic member 1012 abuts against the first stopper 1011, and the first elastic member 1012 biases, through the first stopper 1011, the connecting column in a direction facing away from the seat plate 100, that is, in a direction to engage with the first adjustment hole and the second adjustment hole. Specifically, in this embodiment, the first elastic member 1012 is a coil spring, and the coil spring surrounds the connecting column and simultaneously abuts against the back surface of the side of the base 110 facing the seat plate 100 and the first stopper 1011. The coil spring biases, through the first stopper 1011, the connecting column in a direction facing away from the seat plate 100, thereby biasing the seat plate 100 towards the base 110. When the seat plate 100 is lifted, a bias provided by the coil spring is required to be overcome to lift the seat plate 100. After an external force used to lift the seat plate 100 is removed, the seat plate 100 falls back towards the base 110 under the action of the coil spring. If the seat plate 100 is at the first position or the second position in this case, the adjustment column will be inserted into the first adjustment hole or second adjustment hole. Biasing the seat plate 100 towards the base 110 through the first elastic member 1012 is very advantageous in actual use of the child safety seat. The user does not need to press the seat plate 100 towards the base 110 while sliding the seat plate 100, but only needs to slide the seat plate 100. When the seat plate 100 reaches the first position or the second position, under the action of the first elastic member 1012, the adjustment column will be automatically inserted into the first adjustment hole or the second adjustment hole, and the seat plate 100 will automatically fall back to an initial height. The arrangement of the first elastic member 1012 simplifies sliding and adjustment of the seat plate 100 in at least the following two aspects.

a) It is easy to adjust the position of the seat plate. When sliding the seat plate 100, the user cannot observe the first adjustment portion 102, the second adjustment portion 112, and the third adjustment portion 113, and therefore cannot visually judge whether the seat plate 100 has reached the first position or the second position. Through the arrangement of the first elastic member 1012, when the seat plate 100 reaches the first position or the second position, the adjustment column automatically enters the first adjustment hole or the second adjustment hole under an elastic force of the first elastic member 1012, thereby preventing the user's workload of searching for the first position or the second position.

b) The seat plate automatically resets. Through the arrangement of the first elastic member 1012, when the seat plate 100 reaches the first position or the second position, the adjustment column will be automatically inserted into the first adjustment hole or the second adjustment hole, and the seat plate 100 will automatically fall back to the initial height, thereby saving the user's workload of pressing down the seat plate 100 to cause the seat plate to fall back to the initial height.

Optionally, each connecting column is provided with the first elastic member 1012.

Referring to FIG. 5 again, in the embodiment shown in FIG. 5, a side of the base 110 facing the seat plate 100 is provided with a receiving groove 115, the receiving groove 115 is positioned closer to a front end of the base 110 than the second through hole 114, and the receiving groove 115 and a region of the seat plate 100 corresponding to the receiving groove 115 form a receiving space to receive the crotch strap and a crotch strap lock buckle. Those skilled in the art should understand that the size and the position of the receiving groove 115 may be reasonably selected according to an actual requirement, which is not limited in the present disclosure. Further, in the embodiment shown in FIG. 5, a first concave portion 116 is formed on a side of a front end of the base 110 facing the seat plate 100, the first concave portion 116 is formed by recessing a side of the base 110 facing the seat plate 100 in a direction away from the seat plate 100, and the first concave portion 116 forms an operating space between a front end of the seat plate 100 and the front end of the base 110. In an actual operation, after placing one hand into the operating space, the user pushes against a side of the front end of the seat plate 100 facing the operating space to lift the seat plate 100. Further, referring to FIG. 4A and FIG. 4B, the side of the front end of the seat plate 100 facing the operating space is provided with a third concave portion 104, and the user places one hand into the operating space and then grasps a front edge of the third concave portion 104 to facilitate lifting and sliding of the seat plate 100. Referring to FIG. 7 again, in the embodiment shown in FIG. 7, a gap 120 allowing an adjustment belt used to adjust the length of the safety belt (shoulder strap) to pass through is formed between a side of the front end of the base 110 facing the seat plate 100 and a side of the front end of the seat plate 100 facing the base 110.

Referring to FIG. 9 to FIG. 11, FIG. 9 is a schematic perspective view of the child safety seat 1 according to an embodiment of the present disclosure, in which the seat plate 200 is at the second position; FIG. 10 is a schematic side view of the child safety seat 1 according to an embodiment of the present disclosure, in which the seat plate 200 is at the second position, and in this case, the child safety seat 1 provides a longer riding length in the front-rear direction and is suitable for riding by a larger child; and FIG. 11 is a schematic side view of the child safety seat 1 according to an embodiment of the present disclosure, in which the seat plate 200 is at the first position, and in this case, the child safety seat 1 provides a riding length in the front-rear direction that is shorter than a riding length when the seat plate 200 is at the second position and is suitable for riding by a smaller child. In the embodiments of the present disclosure, the child safety seat 1 includes a seat plate adjustment system 10. The seat plate adjustment system 10 includes a seat plate 200 and a base 210. The seat plate 200 is slidably connected to the base 210, and the seat plate 200 is slidable between a first position and a second position relative to the base. Referring to FIG. 10 and FIG. 11 together, in the child safety seat 1 shown in FIG. 10, the seat plate 210 is at the second position. The seat plate 200 shown in FIG. 10 slides forward along a direction D2 to enter the first position (as shown in FIG. 11). Similarly, the seat plate 200 shown in FIG. 11 slides backward along a direction D1 opposite to the direction D2 to enter the second position (as shown in FIG. 10). The seat plate 200 has a first through hole 2001 configured to be thread by a crotch strap and a first concave portion 2201 used to operate the seat plate 200. In this embodiment, the first through hole 2001 and the first concave portion 2102 are similar in structure and function to the first through hole 103′ and the first concave portion 2201 in the embodiments shown in FIG. 4B and FIG. 5, which are not repeated herein.

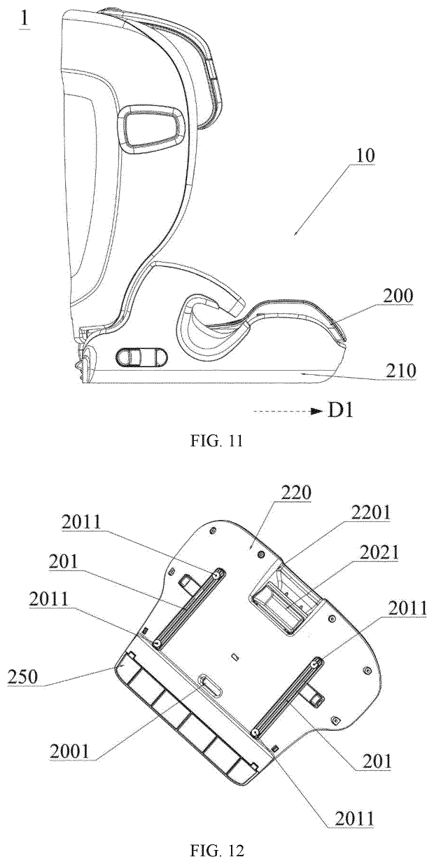

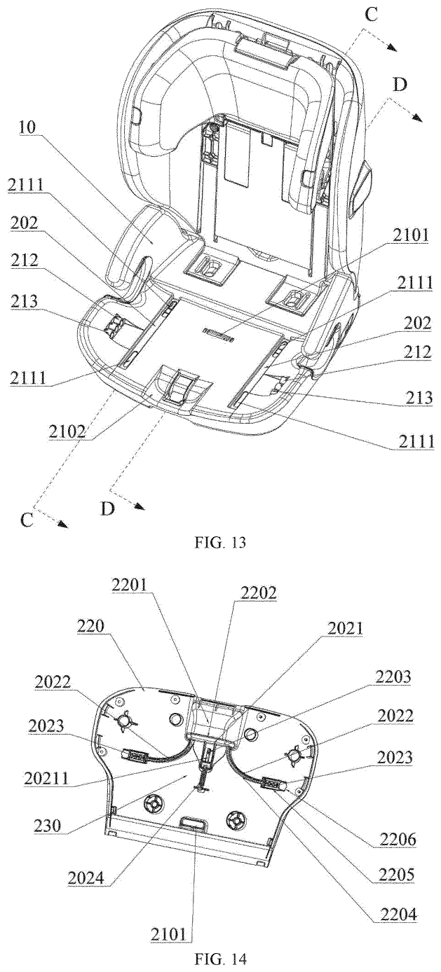

Referring to FIG. 12 to FIG. 14, FIG. 12 is a schematic structural diagram of the seat plate according to an embodiment of the present disclosure; FIG. 13 is a schematic perspective view of the child safety seat according to an embodiment of the present disclosure, in which the seat plate is in a hidden state; and FIG. 14 is a schematic structural diagram of the seat plate 200 according to an embodiment of the present disclosure, in which an upper plate 250 on a side of the seat plate away from the base is removed. In the embodiments shown in FIG. 12 to FIG. 14, the seat plate 200 includes an upper plate 250 and a lower plate 220. The upper plate 250 is connected to the lower plate 220, and a first accommodating space 230 is formed between the upper plate 250 and the lower plate 220. The upper plate 250 and the lower plate 220 are snap-fit to form a stepped structure. For example, a length of the upper plate 250 in the front-rear direction is greater than that of the lower plate 220, so that when the upper plate 250 and the lower plate 220 are snap-fit, the upper plate 250 has a flat portion that does not overlap with the lower plate 220 in a section close to the backrest. A thickness of the flat portion in the vertical direction is less than that of a snap-fit portion between the upper plate 250 and the lower plate 220. A stepped structure is formed on the base 210. When the seat plate 200 is at the first position, the flat portion of the seat plate 200 overlaps with an upper part of the stepped structure of the base 210. When the seat plate 200 slides from the first position to the second position, the flat portion of the upper plate 250 vertically blocks a cavity formed between the lower plate 220 and a lower part of the stepped structure of the base 210, to prevent pinching of buttocks of the child and improve riding experience. A first connecting portion 201 is arranged on a side of the lower plate 220 facing the base 210, the first adjustment portion 202 is arranged on a side of the lower plate 220 away from the base 210, and part of the first adjustment portion 202 is located in the first accommodating space 230.

In this embodiment, the first connecting portion 201 is a convex strip, the convex strip is fixedly arranged on a side of the seat plate 200 facing the base 210, and the convex strip extends in a front-rear direction of the seat plate 200. Specifically, 2 convex strips are provided. Optionally, more or fewer than 2 first connecting portions may be provided, for example, 1 or 4. The number of the first connecting portion may be reasonably selected according to an actual requirement, which is not limited in the present disclosure. Preferably, 2 convex strips are provided. The two convex strips are arranged symmetrically on the seat plate 200 with respect to the vertical direction.

In this embodiment, the second connecting portion 211 is a second connecting groove, the second connecting groove is arranged on a side of the base 210 facing the seat plate 200, the second connecting groove is recessed in a direction away from the seat plate 200, and the second connecting groove extends in a front-rear direction of the base 210. Specifically, two second connecting grooves are provided, and the second connecting grooves are arranged symmetrically on the base 210 with respect to the vertical direction. The second connecting groove is positioned such that the 2 convex strips can be embedded into 2 second connecting grooves respectively and a length of the second connecting groove in the front-rear direction is greater than a length of the convex strip. Therefore, the convex strip is slidable along the second connecting groove. Through the sliding of the convex strip in the second connecting groove, the seat plate 200 slides in the front-rear direction of the base 210, and left and right sliding of the seat plate 200 in the transverse direction of the base 210 is restricted at the same time.

In this embodiment, referring to FIG. 12, a side of the convex strip away from the seat plate 200 is provided with a second stopper 2011, and the second stopper 2011 is connected to the side of the convex strip away from the seat plate 200. Specifically, each convex strip is provided with two second stoppers 2011, and the two second stoppers 2011 are respectively located at two ends of the convex strip. Optionally, each convex strip may be provided with other numbers of second stoppers 2011, such as 1 or 4. Optionally, the second stopper 2011 may be arranged at any position of the convex strip. Those skilled in the art should understand that the size and the position of the second stopper 2011 may be selected according to an actual requirement, which is not limited in the present disclosure. A through groove 2111 is arranged at the bottom of the second connecting groove, the through groove 2111 runs through the bottom of the second connecting groove, and the through groove 2111 extends in the front-rear direction of the base 210. The position and the number of the through groove 2111 correspond to those of the second stopper 2011. After passing through the through groove 2111 from a back side of the second connecting groove, the second stopper 2011 is detachably fixed to the side of the convex strip away from the seat plate 200. Optionally, part of the second stopper 2011 is sized so as not to pass through the through groove 2111. The second stopper 2011 may slide in the through groove 2111. Therefore, a sliding stroke of the second stopper 2011 in the through groove 2111 defines a sliding stroke of the convex strip in the second connecting groove, and defines a sliding stroke of the seat plate 200 in the front-rear direction of the base 210.

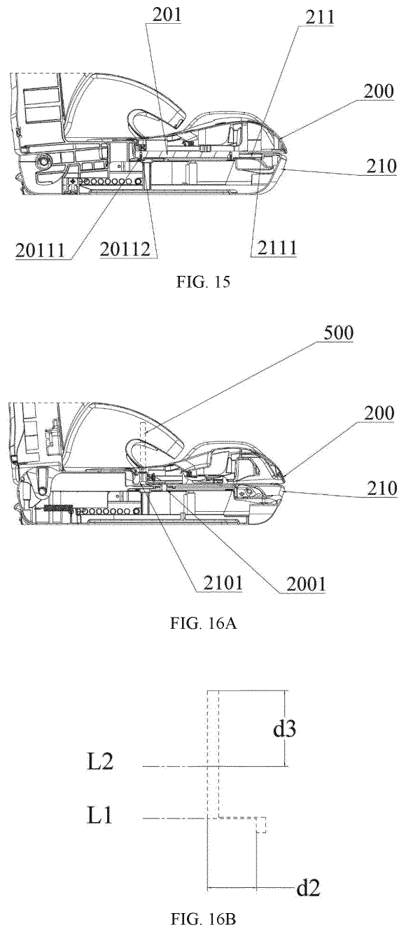

Specifically, referring to FIG. 15, FIG. 15 is a schematic sectional view taken along a line C-C in FIG. 13, in which a backrest structure is partially omitted. In this embodiment, the second stopper 2011 includes a second screw 20111 and a second gasket 20112, the second screw 20111 passes through the through groove 2111 to fix the second gasket 20112 to the side of the convex strip away from the seat plate 200 and press the second gasket 20112 against a back side of the bottom of the second connecting groove, and the second gasket 20112 is sized so as not to pass through the through groove 2111. Through the arrangement of the second stopper 2011, a degree of freedom of the seat plate 200 in the vertical direction is restricted. Therefore, the seat plate 200 cannot be lifted and lowered in the vertical direction relative to the base 210. Those skilled in the art should understand that the gasket is only an example, and the second stopper 2011 may alternatively be another suitable mechanism, such as a thumb screw, which is not limited in the present disclosure.

In an embodiment, a second elastic member (not shown) may be arranged around the second screw 20111, one end of the second elastic member abuts against the back side of the bottom of the second connecting groove, the other end of the second elastic member abuts against the second gasket 20112, and the second elastic member biases, through the second gasket 20112, the second screw 20111 in a direction facing away from the seat plate 200. Specifically, the second elastic member may be a coil spring. The arrangement of the second elastic member can at least prevent gradual loosening of the second screw 20111 during use, thereby prolonging a service life of the seat plate adjustment system.

Referring to FIG. 14, the upper plate 250 and the lower plate 220 define a first accommodating space 230 inside the seat plate 200, the first adjustment portion 202 is at least partially arranged in the first accommodating space 230, and the first adjustment portion 202 includes: an operating member 2021 inserted into a first sliding groove of the lower plate 220 and slidable between a lock position and an adjust position; and a first engaging member 2023. The first engaging member 2023 is operably connected to the operating member 2021, the first engaging member 2023 is slidable between an extend position and a retract position, and the first engaging member 2023 is adapted to be engaged with the second adjustment portion 212 and the third adjustment portion 213. When the operating member 2021 moves to the lock position, the first engaging member 2023 is driven by the operating member 2021 to move to the extend position. In this case, the first engaging member is engaged with the second adjustment portion 212 and the third adjustment portion 213 to restrict the sliding of the seat plate 200 in the front-rear direction, thereby locking the seat plate 200 to the first position or the second position. When the operating member 2021 moves to the adjust position, the first engaging member 2023 is driven by the operating member 2021 to move to the retract position. In this case, the first engaging member is no longer engaged with the second adjustment portion 212 and the third adjustment portion 213, and the seat plate 200 can slide freely in the front-rear direction of the base 210 to adjust the position of the seat plate 200. In addition, the operating member 2021 slides along the front-rear direction, the first engaging member 2023 slides along the transverse direction, and sliding directions of the two are perpendicular to each other. Specifically, the first engaging member 2023 is a cylindrical pin, and the second adjustment portion 212 and the third adjustment portion 213 are insertion holes. Optionally, the first engaging member may alternatively be configured as an element in other shapes, as long as a requirement for engagement with the second adjustment portion 212 and the third adjustment portion 213 can be met.

In this embodiment, since the first engaging member 2023 is operably connected to the operating member 2021, the sliding of the operating member 2021 may change a position of the first engaging member 2023. Specifically, when the seat plate 200 is at the first position, the operating member 2021 is slid to the lock position, so that the first engaging member 2023 slides to the extend position, the first engaging member 2023 is engaged with the second adjustment portion 212, and the seat plate 200 is fixed to the first position; and the operating member 2021 is slid to the adjust position, so that the first engaging member 2023 slides to the retract position, the first engaging member 2023 is disengaged from the second adjustment portion 212, and the seat plate 200 is unfixed from the first position. When the seat plate 200 is at the second position, the operating member 2021 is slid to the lock position, so that the first engaging member 2023 slides to the extend position, the first engaging member 2023 is engaged with the third adjustment portion 213, and the seat plate 200 is fixed to the second position; and the operating member 2021 is slid to the adjust position, so that the first engaging member 2023 slides to the retract position, the first engaging member 2023 is disengaged from the third adjustment portion 213, and the seat plate 200 is unfixed from the second position.

Still referring to FIG. 14, optionally, the first adjustment portion 202 further includes a first connecting member 2022, one end of the first connecting member 2022 is fixedly connected to the operating member 2021, and the other end of the first connecting member 2022 is fixedly connected to the first engaging member 2023. Preferably, the first connecting member 2022 is a flexible connecting strip, and is arranged in an arc-shaped first sliding groove of the lower plate 220. When the first connecting member 2022 slides in the first sliding groove, the first connecting member 2022 can adapt to the shape of the first sliding groove and undergo corresponding deformation, converting forward and backward movement of the operating member 2201 into transverse movement of the first engaging member 2023. Optionally, the first connecting member 2022 is integrated with the operating member 2021.

Referring to FIG. 13 and FIG. 14 together, the second adjustment portion 212 is a third adjustment hole, and the third adjustment portion 213 is a fourth adjustment hole, the third adjustment hole and the fourth adjustment hole are arranged on the side of the base 210 facing the seat plate 200, and the third adjustment hole and the fourth adjustment hole extend in a horizontal direction of the base 210. When the seat plate 200 slides to the first position, the operating member 2021 is slid to the lock position, so that the first engaging member 2023 slides to the extend position. In this case, part of the first engaging member 2023 is inserted into and fixed to the third adjustment hole, thereby restricting the sliding of the seat plate 200 in the front-rear direction, and the seat plate 200 is fixed to the first position. The operating member 2021 is slid to the adjust position so that the first engaging member 2023 slides to the retract position. In this case, the first engaging member 2023 is detached from the third adjustment hole, thereby unrestricting the sliding of the seat plate 200 in the front-rear direction, and the seat plate 200 is unfixed from the first position. When the seat plate 200 slides to the second position, the operating member 2021 is slid to the lock position, so that the first engaging member 2023 slides to the extend position. In this case, part of the first engaging member 2023 is inserted into and fixed to the fourth adjustment hole, thereby restricting the sliding of the seat plate 200 in the front-rear direction, and the seat plate 200 is fixed to the second position. The operating member 2021 is slid to the adjust position so that the first engaging member 2023 slides to the retract position. In this case, the first engaging member is detached from the fourth adjustment hole, thereby unrestricting the sliding of the seat plate 200 in the front-rear direction, and the seat plate 200 is unfixed from the second position.

Still referring to FIG. 14, in an embodiment, the first accommodating space 230 is further provided with a first accommodating groove 2204 and a second accommodating groove 2205 in communication with each other, the first accommodating groove 2204 is adapted to accommodate a first connecting member 2022, and the second accommodating groove 2205 is adapted to accommodate the first engaging member 2023. The first accommodating space 230 is further provided with a third through hole 2206 in communication with the second accommodating groove 2205, and the first engaging member 2023 is capable of partially passing through the third through hole 2206. When the first engaging member 2023 slides to the extend position, one part of the first engaging member 2023 passes through the third through hole 2206 and enters the third adjustment hole or the fourth adjustment hole, and the other part of the first engaging member 2023 is located in the third through hole 2206.

In an embodiment, the seat plate 200 further includes a second concave portion 2201, the second concave portion 2201 is formed by recessing at least part of a side of a front end of the seat plate 200 facing the base 210 in a direction away from the base 210, an opening 2202 is provided in an inner wall of the second concave portion 2201 away from the front end of the seat plate 200, the opening 2202 is in communication with the first accommodating space 230, and the operating member 2021 is slidably arranged in the second concave portion 2201 and is capable of at least partially passing through the opening 2202.

In an embodiment, the first adjustment portion 202 further includes a third elastic member 2024, one end of the third elastic member 2024 is fixedly connected to the operating member 2021, the other end of the third elastic member 2024 is fixedly connected to the seat plate 200, and the third elastic member 2024 causes the operating member 2021 to have a tendency to slide towards the lock position. Preferably, the third elastic member 2024 is a tension spring. Those skilled in the art should understand that the tension spring in this embodiment is only an example, and the third elastic member 2024 may alternatively be a torsion spring or other suitable elements, which is not limited in the present disclosure.

In an embodiment, the operating member 2021 is provided with a limiting groove 20211, the first accommodating space 230 is provided with a limiting convex portion 2203 fitting the limiting groove 20211, and the limiting convex portion 2203 is arranged on a side of the lower plate 220 away from the base 210. The limiting groove 20211 extends in the front-rear direction of the base 210. When a front end of the limiting groove 20211 abuts against the limiting convex portion 2203, the operating member 2021 reaches a first limit position. Optionally, the first limit position corresponds to the lock position of the operating member 2021. When a rear end of the limiting groove 20211 abuts against the limiting convex portion 2203, the operating member 2021 reaches a second limit position. Optionally, the second limit position corresponds to the adjust position of the operating member 2021.

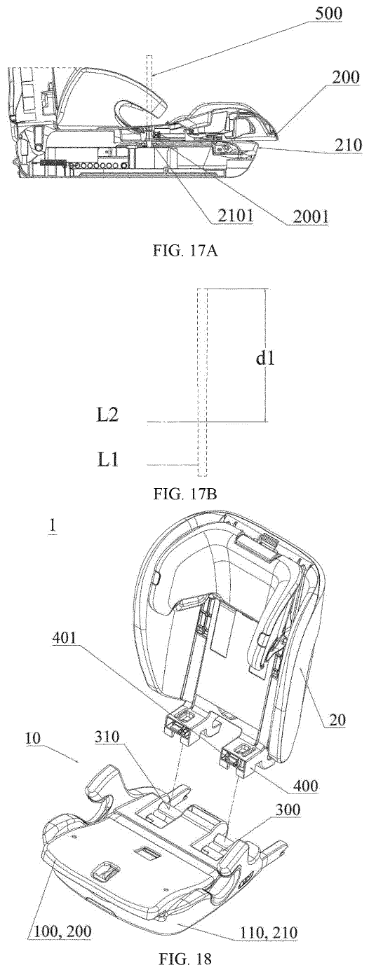

An influence of the sliding of the seat plate between the first position and the second position on the safety belt (such as the crotch strap) will be further explained below with reference to FIG. 16A, FIG. 16B, FIG. 17A, and FIG. 17B. In this embodiment, when the seat plate 100 is at the first position, a projection of the second through hole 2101 in the vertical direction does not overlap with a projection of the first through hole 2001 in the vertical direction (refer to FIG. 16A). When the seat plate 100 is at the second position, at least part of the projection of the second through hole 2101 in the vertical direction overlaps with the projection of the first through hole 2001 in the vertical direction (refer to FIG. 17A). A second accommodating space adapted to accommodate a safety belt is formed between the seat plate 200 and the base 210. Therefore, when the seat plate 200 is at the first position, the safety belt passing through the first through hole 2001 and the second through hole 2101 may be folded, and part of the safety belt may be in the second accommodating space. Referring to FIG. 16B and FIG. 17B, L1 denotes a height of an upper edge of the second through hole 2101 in the vertical direction, L2 denotes a height of an upper edge of the first through hole 2001 in the vertical direction, and the dotted line denotes the safety belt. Therefore, the dotted line above L2 is used to denote a length of the safety belt passing through the first through hole 2001. In FIG. 16B, the seat plate 200 is at the first position, the safety belt is folded in the front-rear direction, a length of the folded part of the safety belt is d2, and the length of the safety belt passing through the first through hole 2001 is d3. In FIG. 17B, the seat plate 200 is at the second position, the safety belt is not folded, a length of the safety belt passing through the first through hole 2001 is d1. Therefore, d1=d2+d3. That is, a length of the safety belt entering and passing through the first through hole 2001 when the seat plate 200 is at the first position is less than a length of the safety belt entering and passing through the first through hole 2001 when the seat plate 200 is at the second position. When the seat plate 200 is at the first position, the seat is shorter and suitable for a smaller child. Further, the safety belt for a smaller child is also shorter. In addition, when the seat plate 200 slides from the first position to the second position, the position of the first through hole 203 also moves forward by a distance of d2, and drives the position of the crotch strap to move forward. That is, when the seat plate 200 slides from the first position to the second position, a distance between the crotch strap and the backrest is increased by the length d2 compared with the seat plate 200 at the first position, thereby leaving more riding space for a crotch of a larger children in the front-rear direction. Therefore, when the seat plate 200 is at the first position, the seat plate adjustment system 10 according to the embodiments of the present disclosure can reduce a workload of shortening the safety belt and improve ease of use of the child safety seat.

Referring to FIG. 18 to FIG. 20, the embodiments of the present disclosure further provide a child safety seat 1, including the seat plate adjustment system 10 in the foregoing embodiments; and a backrest 20. The backrest 20 is detachably connected to the base 110 or 210.

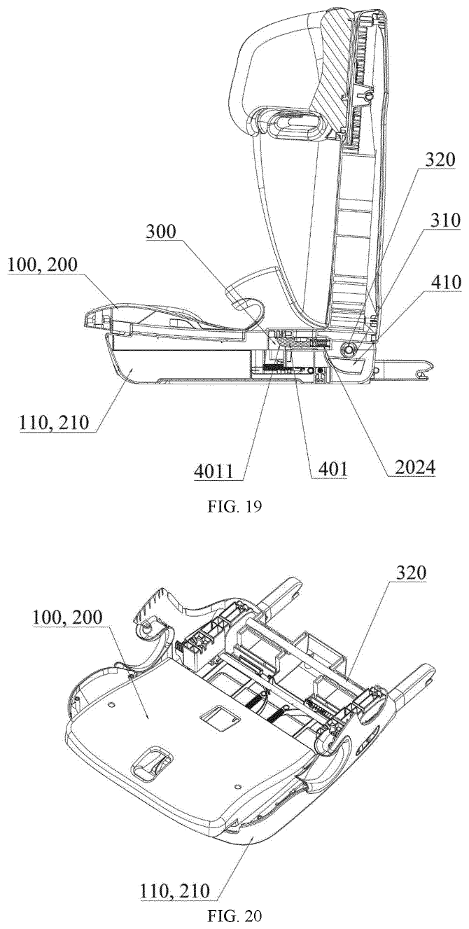

Referring to FIG. 19, in an embodiment, the base 110 or 210 includes an engaging groove 300, the backrest 20 includes an engaging portion 400, and the engaging portion 400 is engaged in the engaging groove 300. Specifically, the engaging portion 400 includes a lock tongue 401, and the lock tongue 401 is slidable in a front-rear direction to switch between a lock position and an unlock position. At the lock position, the lock tongue slides into the engaging groove 300 to be engaged in the engaging groove 300, and at the unlock position, the lock tongue 401 slides in a direction away from the engaging groove 300 to be disengaged from the engaging groove 300 and be unlocked from the engaging groove 300. Optionally, the engaging portion 400 further includes a fourth elastic member 2024, and the fourth elastic member 2024 causes the lock tongue 401 to have a tendency to slide towards the engaging groove 300. Preferably, the fourth elastic member 2024 is a coil spring. Those skilled in the art should understand that the coil spring is only an example, and the fourth elastic member 2024 may be any other suitable elastic elements.

Referring to FIG. 19, in an embodiment, a front end 401 of the lock tongue is provided with a curved portion 4011, a pressing force is applied to the curved portion 4011, and the lock tongue 401 slides towards the unlock position. During the mounting, the curved portion 4011 abuts against an edge of the engaging groove 300, and the lock tongue 401 is pressed, so the lock tongue 401 slides towards the unlock position. When the lock tongue 401 completely enters the engaging groove 300, under the action of the fourth elastic member 2024, the lock tongue 401 slides towards the engaging groove 300 to the lock position.

Referring to FIG. 19 and FIG. 20, in an embodiment, the base 110 or 210 includes a connecting rod 310, and the connecting rod 310 is arranged at a rear end of the base 110 or 210. The backrest 20 includes a hook portion 410. The hook portion 410 hooks the connecting rod 310 to be jointed with the connecting rod 310. The base 110 or 210 further includes a reinforcing tube 320. The reinforcing tube 320 is arranged in the connecting rod 310 to improve structural strength of the connecting rod. In addition, since the reinforcing tube 320 is connected to a base bracket, the backrest 20 has better connection strength. In some embodiments, the reinforcing tube and the base bracket are made of steel, and are welded or tightly fitted together.

Mounting and disassembly processes of the backrest 20 will be described below with reference to FIG. 18 and FIG. 19.

Referring to FIG. 18, the backrest 20 and the base 110 or 210 are in a disassembled state. Firstly, the hook portion 410 is hooked to the connecting rod 310. Then, the backrest 20 is rotated with the connecting rod 310 as a pivot until the curved portion 4011 of the lock tongue 401 contacts the edge of the engaging groove 300. The lock tongue 401 is pressed towards the engaging groove, causing the lock tongue 401 to retract towards the unlock position until the lock tongue 401 enters the engaging groove 300. Under the action of the fourth elastic member 2024, the lock tongue 401 slides towards the engaging groove 300 to the lock position. So far, the backrest 20 has been mounted.

Referring to FIG. 19, the backrest 20 and the base 110 or 210 are in a mounted state. Firstly, the lock tongue 401 is pushed to the unlock position. The backrest is rotated with the connecting rod 310 as a pivot while the lock tongue 401 is kept at the unlock position. The lock tongue 401 is unlocked after leaving the engaging groove 300. The backrest is moved in a direction opposite to an opening of the hook portion 410 to unhook the hook portion 410 from the connecting rod 310. So far, the backrest 20 has been disassembled.

In the child safety seat provided in the embodiments of the present disclosure, through the engagement between the engaging groove 300 and the engaging portion 400 and the hooking between the hook portion 410 and the connecting rod 310, the backrest can be mounted and disassembled quickly and easily, having high ease of use.

Referring to FIG. 9 to FIG. 17, the present disclosure further provides a seat plate adjustment system for a child safety seat 1, including a seat plate 200 and a base 210. The seat plate 200 is movable between a first position and a second position in a first direction relative to the base 210. The seat plate 200 further includes: an adjustment portion 202, a connecting portion 201, and a first through hole 2001 configured to be thread by a crotch strap. The base 210 includes a second through hole 2101 configured to be thread by the crotch strap. The adjustment portion 202 is operable to restrict movement of the seat plate 200 in the first direction relative to the base 210. That is, the user may restrict and unrestrict movement of the seat plate 200 in the front-rear direction by switching the operating member 2021 between the lock position and the adjust position. The connecting portion 201 restricts movement of the seat plate 200 in the second direction relative to the base 210. The first direction is a front-rear direction, the second direction is a transverse direction, and the second direction is perpendicular to the first direction. When the seat plate 200 is at the first position, a projection of the second through hole 2101 in the vertical direction does not overlap with a projection of the first through hole 2001 in the vertical direction. In this case, an exposed length of the crotch strap is short, and an exposed position of the crotch strap is close to the backrest, which is suitable for a smaller child. When the seat plate 200 is at the second position, at least part of the projection of the second through hole 2101 in the vertical direction overlaps with the projection of the first through hole 2001 in the vertical direction. In this case, the exposed length of the crotch strap is longer, and the exposed position of the crotch strap is away from the backrest, which is suitable for a larger child. Therefore, the length and the position of the crotch strap may be adjusted while the seat cushion length of the child safety seat 1 is adjusted.

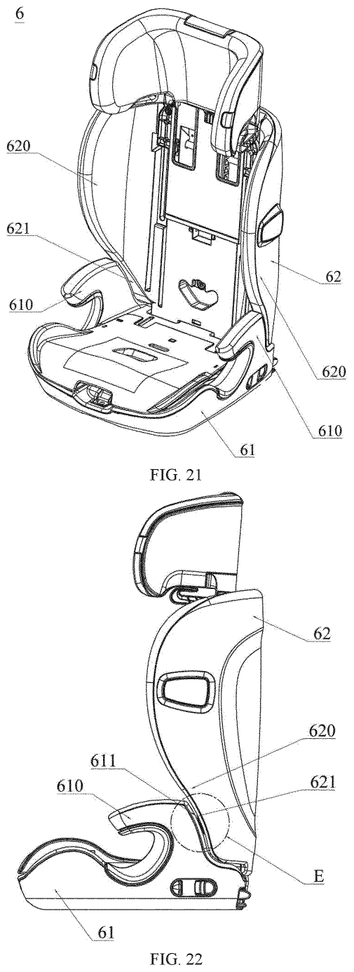

Referring to FIG. 21 and FIG. 22, the embodiments of the present disclosure further provide a child safety seat 6, including a base 61 and a backrest 62 connected to the base 61. The base 61 is provided with an armrest 610. Optionally, the base 61 and the armrest 610 are integrated. Wing portions 620 extending from the backrest 62 are respectively arranged on two transverse sides of the backrest 62. In some embodiments, the backrest 62 is pivotably connected to the base 61, so that an angle of the backrest 62 can be adjusted. When the backrest 62 pivots relative to the base 61, a distance between the armrest 610 and the wing portion 620 also changes accordingly. In some other embodiments, the backrest 62 is detachably connected to the base 61 through pivoting or insertion. The wing portion 620 and the armrest 610 are independent components. In a use state, there is a gap between the wing portion 620 and the armrest 610. In the case of a traffic accident such as emergency braking or vehicle collision, under the action of inertia, the backrest 62 pivots forward (i.e., the direction D1 shown in FIG. 2 and FIG. 11) with a connecting portion between the backrest 62 and the base 61 as a rotation axis, and the wing portion 620 may be pressed against the armrest 610, whereby the armrest 610 supports the backrest 62 to restrict excessive forward pivoting of the backrest 62. However, in actual use, in the case of improper mounting by the user or insufficient hardness of a material of the backrest 62, the wing portions 620 on the two sides of the backrest 62 may deform under a combined action of inertia of forward pivoting of the backrest 62 and a support force provided by the armrest 610. Specifically, the wing portions 620 on the two sides of the backrest 62 may deform towards an outer side in the transverse direction. For example, the wing portions 620 on the two sides of the backrest 62 spread outwards or are transversely misaligned with a contact surface of the armrest 610. In this case, the backrest 62 will continue to pivot forward. As a result, the head and neck of the child sitting in the child safety seat 6 are excessively flexed and stretched forward under the pressure of the backrest 62. Under extreme conditions such as vehicle seats excessively narrowly spaced, the head of the child may touch the backrest of the vehicle seat in front. The term “towards an outer side” in the present disclosure refers to a direction away from the child safety seat 6 in the transverse direction.

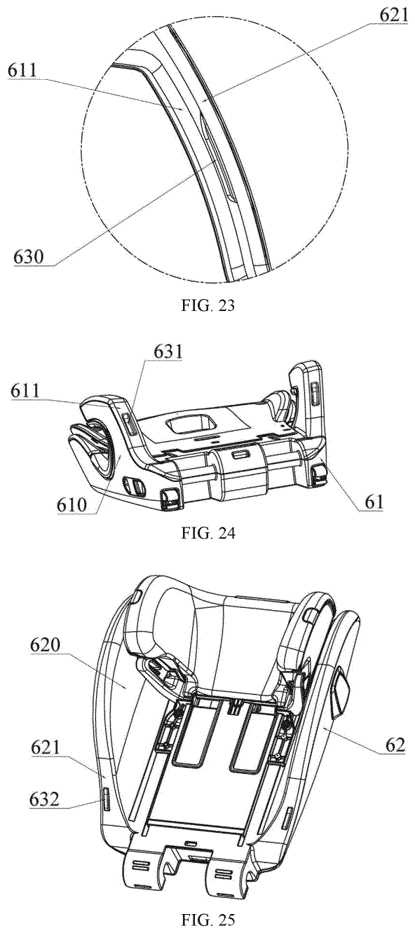

Referring to FIG. 22 and FIG. 23, in an embodiment of the present disclosure, a side of the armrest 610 facing the wing portion 620 is provided with a first surface 611, a side of an edge of the wing portion 620 facing the armrest 610 is provided with a second surface 621, and the first surface 611 and the second surface 621 are arranged opposite to each other. That is, when the backrest 62 moves forward (e.g., pivots) due to an accident, the second surface 621 may be pressed towards the first surface 611 and come into contact with the first surface 611. The first surface 611 and the second surface 621 are provided with a limiting mechanism 630. The limiting mechanism 630 is configured to prevent deformation of the wing portion 620 in the transverse direction when the wing portion 620 presses the armrest 610, thereby preventing continuous forward movement of the backrest 62 and ensuring life safety of the child sitting in the child safety seat 6.

Referring to FIG. 24 and FIG. 25, in an embodiment, the limiting mechanism 630 includes: a positioning recess 631 arranged on the first surface 611 and a first positioning protrusion 632 arranged on the second surface 621. When the wing portion 620 presses the armrest 610, the first positioning protrusion 632 can be inserted into the positioning recess 631 to restrict deformation of the wing portion 620 in the transverse direction, thereby preventing continuous forward movement of the backrest 62 and ensuring life safety of the child sitting in the child safety seat 6. Optionally, in other embodiments, the positioning recess 631 and the first positioning protrusion 632 may alternatively be arranged oppositely. That is, the positioning recess 631 is arranged on the second surface 621, and the first positioning protrusion 632 is arranged on the first surface 611. Optionally, the positioning recess 631 is configured as an elongated rectangular structure, and is recessed away from the first surface 611 or the second surface 621 where the positioning recess 631 is located. Optionally, the first positioning protrusion 632 is configured as an elongated rectangular structure similar in shape to the positioning recess 631 but slightly smaller in size, and protrudes away from the second surface 621 or the first surface 611 where the positioning recess 631 is located. In such embodiments, the first positioning protrusion 632 is in clearance fit with the positioning recess 631. Optionally, the positioning recess 631 and the first positioning protrusion 632 may alternatively be set to other suitable shapes according to an actual requirement. For example, the positioning recess 631 is in a fan shape or an inverted trapezoid whose width gradually narrows along the front-rear direction, which is not limited in the present disclosure.

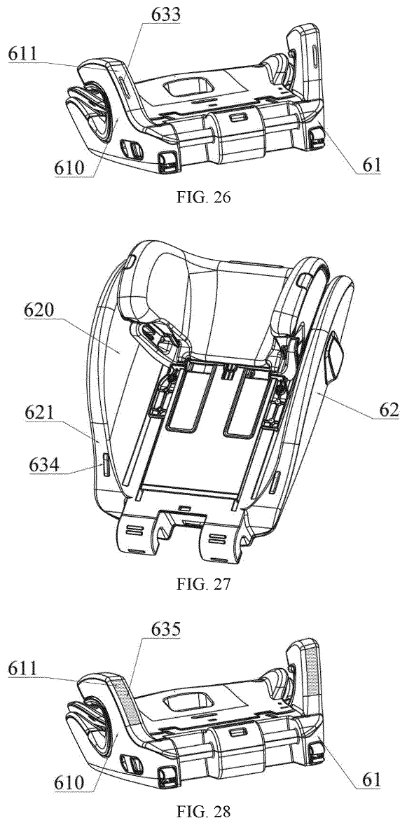

Referring to FIG. 26 and FIG. 27, in an embodiment, the limiting mechanism 630 includes: a second positioning protrusion 633 arranged on the first surface 611 and a third positioning protrusion 634 arranged on the second surface 621. Specifically, the second positioning protrusion 633 is arranged on the outer side in the transverse direction relative to the third positioning protrusion 634. When the wing portion 620 presses the armrest 610, projections of the second positioning protrusion 633 and the third positioning protrusion 634 in the transverse direction at least partially overlap. Therefore, the second positioning protrusion 633 can restrict movement of the third positioning protrusion 634 towards the outer side in the transverse direction to restrict the deformation of the wing portion 620 in the transverse direction, so as to prevent continuous forward movement of the backrest 62 and ensure life safety of the child sitting in the child safety seat 6. Optionally, in other embodiments, two second positioning protrusions 633 may be arranged on the first surface 611, and the third positioning protrusion 634 is positioned such that when the wing portion 620 presses the armrest 610, the third positioning protrusion 634 can enter a gap formed between the two second positioning protrusions 633 to restrict deformation of the wing portion 620 in the transverse direction. Optionally, in other embodiments, two third positioning protrusions 634 may be arranged on the second surface 621, and the second positioning protrusion 633 is positioned such that when the wing portion 620 presses the armrest 610, the second positioning protrusion 633 can enter a gap formed between the two third positioning protrusions 634 to limit deformation of the wing portion 620 in the transverse direction. Specifically, the second positioning protrusion 633 and the third positioning protrusion 634 are configured as elongated rectangular structures and protrude away from the second surface 621 or the first surface 611 where the second positioning protrusion 633 and the third positioning protrusion 634 are located. Optionally, the second positioning protrusion 633 and the third positioning protrusion 634 may alternatively be set to other suitable shapes according to an actual requirement, for example, a fan shape or an inverted trapezoid whose width gradually narrows along the front-rear direction, which are not limited in the present disclosure.

Referring to FIG. 28 and FIG. 29, in an embodiment, the limiting mechanism 630 includes: a friction member 635. The friction member 635 is arranged on at least one of the first surface 611 and the second surface 621. When the wing portions 620 press the armrest 610, the friction member 635 provides a friction force that restricts the transverse movement of the wing portions 620 relative to the armrest 610. Therefore, continuous forward movement of the backrest 62 is prevented, and life safety of the child sitting in the child safety seat 6 is ensured. Optionally, the friction member 635 is a friction plate mounted on the first surface 611 and/or the second surface 621, or the friction member 635 may be a rough surface formed on the first surface 611 and/or the second surface 621. The friction member 635 may be appropriately implemented according to an actual requirement, as long as a friction force that restricts the transverse movement of the wing portion 620 relative to the armrest 610 can be provided.

Referring to FIG. 30 and FIG. 31, in an embodiment, the limiting mechanism 630 includes: at least two limiting ribs 636. The at least two limiting ribs 636 are arranged on one of the first surface 611 and the second surface 621, and are respectively located on two sides of an edge of the first surface 611 or the second surface 621 in the transverse direction. When the wing portion 620 presses the armrest 610 to cause the first surface 611 to contact the second surface 621, the at least two limiting ribs 636 hold the other one of the first surface 611 and the second surface 621 to restrict transverse movement of the wing portion 620 relative to the armrest 610. Therefore, continuous forward movement of the backrest 62 is prevented, and life safety of the child sitting in the child safety seat 6 is ensured. Optionally, the at least two limiting ribs 636 are arranged as ribs protruding towards two sides of the armrest 610 to form at least a partial V-shaped or U-shaped space between the at least two limiting ribs 636. Optionally, the limiting mechanism 630 may further include a protruding portion (not shown) arranged on the other of the first surface 611 and the second surface 621. The protruding portion has a shape matching a space formed between the at least two limiting ribs 636, such as at least a partial V shape or U shape. When the wing portion 620 presses the armrest 610, the protruding portion may enter the space formed between the at least two limiting ribs 636, that is, the at least two limiting ribs 636 hold the protruding portion to restrict transverse movement of the wing portion 620 relative to the armrest 610.

In a child safety seat with ISOFIX known to the inventor, the seat is provided with an unlock key configured to contact an ISOFIX connector, and a safety key configured to prevent accidental triggering of the unlock key. If only the unlock key is pressed when the safety key is not pressed, the ISOFIX connector cannot be unlocked, thereby preventing accidental triggering. After the safety key and the unlock key are pressed at the same time, the ISOFIX connector is unlocked, thereby separating the child safety seat from a vehicle. An unlocking direction of the safety key and an unlocking direction of the unlock key are on a same straight line or two parallel straight lines, and the unlocking directions of the two are close to each other. In addition, since the unlock key and the ISOFIX connector are mostly rigidly connected, the ISOFIX connector is adjustable fore and aft relative to a seat back of the child safety seat. Therefore, according to the child safety seat known to the inventor, the unlock key is generally arranged on a housing of the ISOFIX connector and moves forward and backward with the ISOFIX connector relative to the seat back.

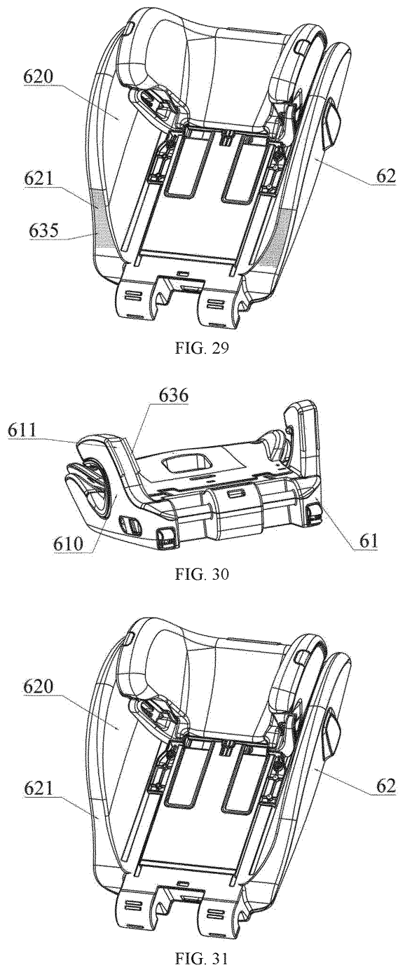

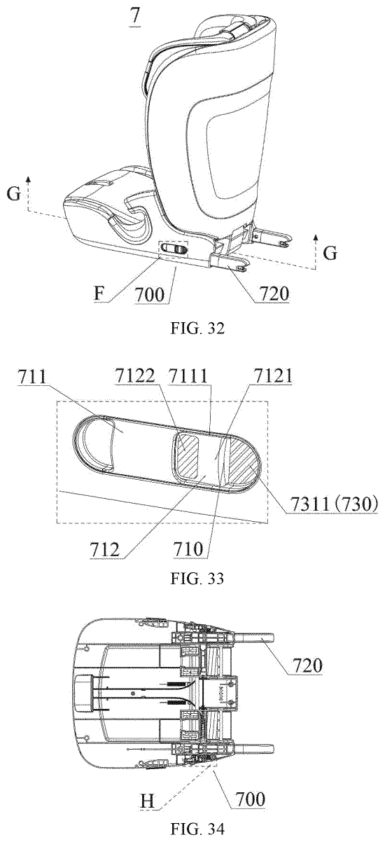

Referring to FIG. 32, a child safety seat 7 according to an embodiment of the present disclosure includes an ISOFIX safety unlock system 700. The ISOFIX safety unlock system 700 can be detachably connected to an IOSFIX interface (not shown) of a vehicle.

Referring to FIG. 33 to FIG. 34, the ISOFIX safety unlock system 700 includes an IOSFIX connector 720, a first unlocking apparatus 710, and a second unlocking apparatus 730. The ISOFIX connector 720 is switchable between a locked state and an unlocked state. When the ISOFIX connector 720 is in the locked state, the ISOFIX connector 720 can be locked with the IOSFIX interface of the vehicle. When the ISOFIX connector 720 is in the unlocked state, the ISOFIX connector 720 can be separated from the IOSFIX interface of the vehicle. The first unlocking apparatus 710 is operably connected directly or indirectly to the ISOFIX connector 720 to operate the ISOFIX connector 720 to unlock. The first unlocking apparatus 710 includes a first unlocking operating portion 712. The first unlocking operating portion 712 is slidable between a lock position and an unlock position. When the first unlocking operating portion 712 switches from the lock position to the unlock position, the first unlocking apparatus 710 may switch the ISOFIX connector 720 from the locked state to the unlocked state. The second unlocking apparatus 730 is operably connected to the first unlocking apparatus 710. The second unlocking apparatus 730 includes a second unlocking operating portion 7311. The second unlocking operating portion 7311 is slidable between a safe position and a free position. When the second unlocking operating portion 7311 is at the safe position, the second unlocking apparatus 730 locks the first unlocking operating portion 712 to the lock position. A sliding direction of the first unlocking operating portion 712 is not parallel to a sliding direction of the second unlocking operating portion 7311. In this embodiment, the sliding direction of the first unlocking operating portion 712 is perpendicular to the sliding direction of the second unlocking operating portion 7311. Specifically, the first unlocking operating portion 712 slides along a longitudinal direction of the child safety seat 7, and the second unlocking operating portion 7311 moves along a transverse direction of the child safety seat 7. The longitudinal direction refers to a direction the child faces when riding in the child safety seat 7, and the transverse direction refers to a direction perpendicular to the longitudinal direction. For example, in some other embodiments, the sliding direction of the first unlocking operating portion 712 intersects the sliding direction of the second unlocking operating portion 7311. For example, the sliding direction of the first unlocking operating portion 712 switching from the locked state to the unlocked state and the sliding direction of the second unlocking operating portion 7311 switching from the locked state to the unlocked state are at an angle of less than 45 degrees. In some other embodiments, the sliding direction of the first unlocking operating portion 712 and the sliding direction of the second unlocking operating portion 7311 are parallel to and away from each other. For example, the sliding direction of the first unlocking operating portion 712 switching from the locked state to the unlocked state is exactly opposite to the sliding direction of the second unlocking operating portion 7311 switching from the locked state to the unlocked stat.

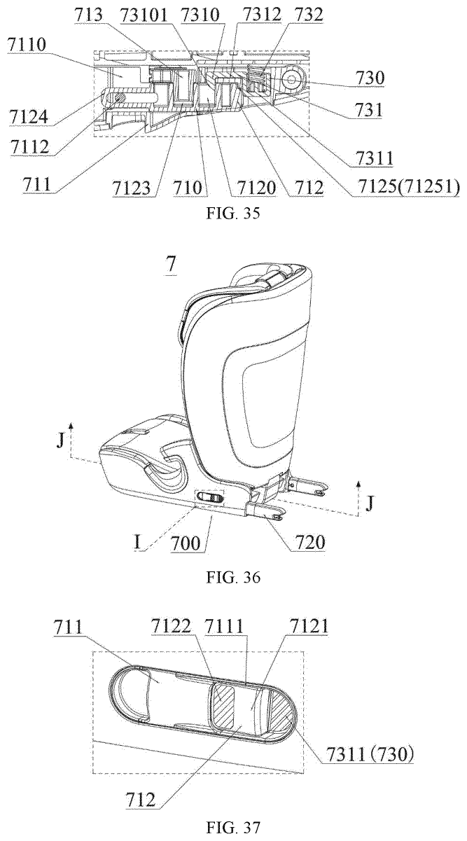

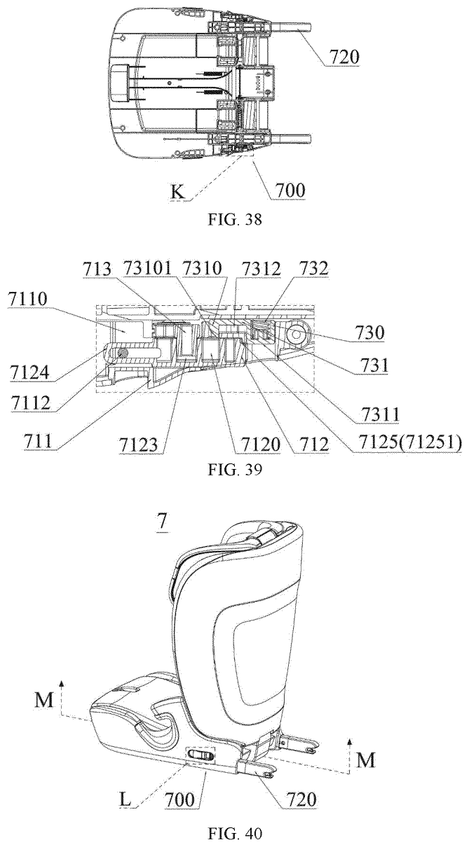

Specifically, as shown in FIG. 35, the first unlocking apparatus 710 includes a first joint portion 7120 and a second joint portion 7125 that are connected to the first unlocking operating portion 712. In FIG. 35, the first unlocking operating portion 712 is at the lock position, and the second unlocking apparatus 730 is at the safe position. The second unlocking apparatus 730 includes a third joint portion 7310. When the first unlocking operating portion 712 is at the lock position and the second unlocking operating portion 7311 is at the safe position, the third joint portion 7310 fits the first joint portion 7120 to lock the first unlocking operating portion 712 to the lock position. In this embodiment, the first joint portion 7120 is a slot, and the third joint portion 7310 is a hook. As shown in FIG. 43, when the first unlocking operating portion 712 is at the unlock position and the second unlocking apparatus 730 is at the free position, the third joint portion 7310 fits the second joint portion 7125 to lock the first unlocking operating portion 712 to the unlock position.

As shown in FIG. 33 and FIG. 37, the first unlocking operating portion 712 includes a first pressing portion 7121 for the user to push the first unlocking operating portion 712 to slide, and the first pressing portion 7121 is a pressing surface substantially perpendicular to the sliding direction of the first unlocking operating portion 712. When the second unlocking operating portion 7311 is at the safe position, a side wall of the second unlocking operating portion 7311 blocks at least part of the first pressing portion 7121 to prevent misoperation on the first unlocking operating portion 712 before the user operates the second unlocking operating portion 7311. When the second unlocking operating portion 7311 is at the free position, the side wall of the second unlocking operating portion 7311 is detached from the first pressing portion 7121, so that the first pressing portion 7121 is exposed, so as to facilitate the user to push the first pressing portion 7121 by hand to slide the first unlocking operating portion 712.

As shown in FIG. 33, the first unlocking apparatus 710 includes a fixed seat 711. The fixed seat 711 is fixedly arranged on the child safety seat 7. When the ISOFOX connector 720 slides back and forth in the longitudinal direction, the position of the fixed seat 711 may not change accordingly, so as to facilitate the user to operate. A third accommodating space 7110 is defined inside the fixed seat 711. The first unlocking operating portion 712 is slidably arranged in the third accommodating space 7110, and may slide from the lock position to the unlock position in a direction away from the second unlocking operating portion 7311. When the user attempts to unlock the ISOFIX connector 720 with one hand, the user first presses the second unlocking operating portion 7311 with a thumb in a direction close to the child safety seat, and presses the second unlocking operating portion 7311 from the safe position to the free position; and then uses an index finger to push the first unlocking operating portion 712 away from the second unlocking operating portion 7311 (the thumb). Force provided by human hand muscles to push the index finger away from the thumb is much less than force to pull the index finger closer to the thumb, and it may be difficult for the user to unlock the ISOFIX connector 720 with one hand, or touch the first unlocking operating portion 712 and the second unlocking operating portion 7311 at the same time and cause accidental unlocking when adjusting a front-rear distance of ISOFIX connector 720 relative to the backrest. Therefore, unlocking caused by an accidental touch of a child when riding in the child safety seat can be effectively prevented. In other embodiments, the first unlocking operating portion 712 may alternatively slide from the lock position to the unlock position in a direction close to the second unlocking operating portion 7311.

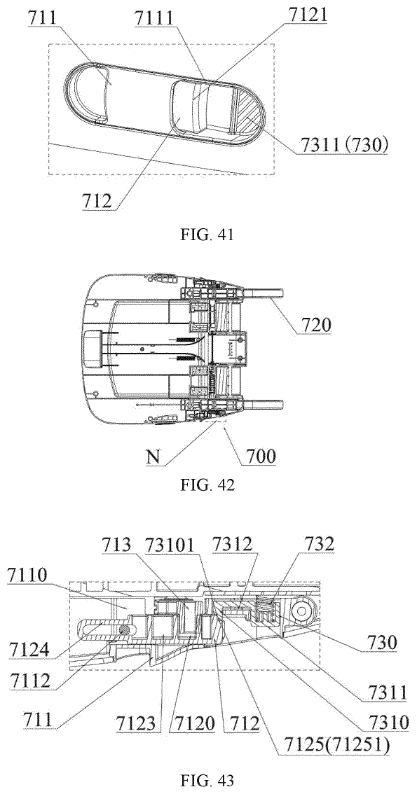

As shown in FIG. 33, a side of the fixed seat 711 away from the child safety seat 7 is provided with an observation window 7111. The first pressing portion 7121 is located within the observation window 7111. The first unlocking operating portion 712 includes a color indicator 7122 connected to the first pressing portion 7121. The color indicator 7122 may be, for example, be marked green. When the first unlocking operating portion 712 is at the lock position, the color indicator 7122 is exposed within the observation window 7111, that is, can be observed by the user, prompting the user that the ISOFIX connector 720 has been locked. A pushing force is applied to the first pressing portion 7121, so that the first unlocking operating portion 712 slides from the lock position to the unlock position. As shown in FIG. 41, when the first unlocking operating portion 712 is at the unlock position, the color indicator 7122 is shielded by the fixed seat 711, that is, cannot be observed by the user, prompting the user that the ISOFIX connector 720 is in the unlocked state.

As shown in FIG. 35, FIG. 39, and FIG. 43, the first unlocking apparatus 710 further includes a first guide member 7124 located at an end of the first unlocking operating portion 712 away from the second unlocking apparatus 730. A second guide member 7112 is arranged on the fixed seat 711 at a position corresponding to the first guide member 7124. The first guide member 7124 fits the second guide member 7112 to guide sliding of the first unlocking operating portion 712. In this embodiment, the first guide member 7124 is a second sliding groove, and the second guide member 7112 is a pin that may slide in the second sliding groove, but is not limited thereto.

As shown in FIG. 35, FIG. 39, and FIG. 43, the second unlocking apparatus 730 includes a main body portion 731. The main body portion 731 has a limiting space 7312. The limiting space 7312 is arranged between the third joint portion 7310 and the second unlocking operating portion 7311. When the second unlocking operating portion 7311 is at the safe position, part of the first unlocking operating portion 712 enters the limiting space 7312, so that the third joint portion 7310 fits the first joint portion 7120. When the second unlocking operating portion 7311 is at the free position, the part of the first unlocking operating portion 712 is detached from the limiting space 7312, thereby facilitating the user to slide the first unlocking operating portion 712.

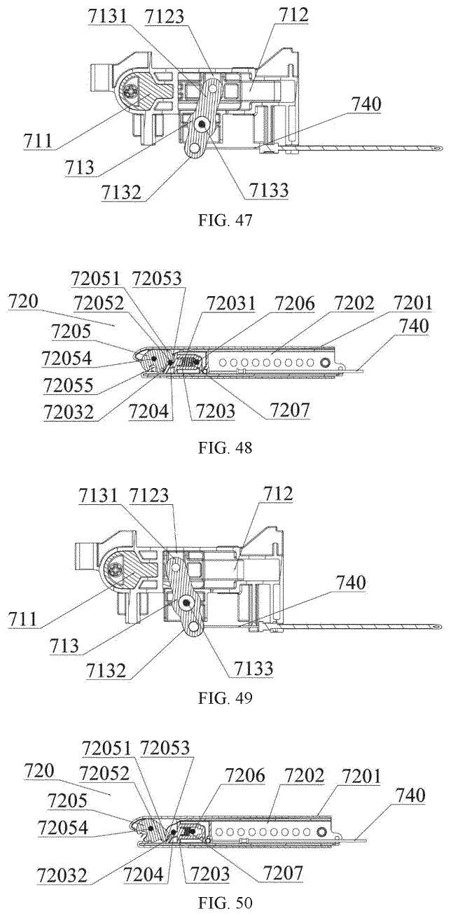

As shown in FIG. 35, FIG. 39, and FIG. 43, the second unlocking apparatus 730 further includes a fifth elastic member 732 connected to the second unlocking operating portion 7311. The fifth elastic member 732 has a tendency to slide the second unlocking operating portion 7311 from the free position towards the safe position. In this embodiment, the fifth elastic member 732 is a spring. The third joint portion 7310 has a first surface and a second surface opposite to the first surface. The first surface of the third joint portion 7310 is a plane in a direction away from the first unlocking apparatus 710, and a second surface of the third joint portion 7310 is a chamfered surface 73101. The chamfered surface 73101 is in a direction close to one side of the first unlocking apparatus 710. The second joint portion 7125 is provided with a step surface 71251. Referring to FIG. 35, when the second unlocking apparatus 730 is at the safe position and the first unlocking operating portion 712 is at the lock position, the third joint portion 7310 contacts the first surface of the first unlocking apparatus 710 through the first surface to lock the first unlocking apparatus 710 to the lock position. Referring to FIG. 43, when the second unlocking apparatus 730 is at the free position and the first unlocking operating portion 712 is at the unlock position, the chamfered surface 73101 abuts against the step surface 71251 (i.e., the second surface of the first unlocking apparatus 710), and under the action of the fifth elastic member 732, the third joint portion 7310 restricts movement of the first unlocking operating portion 712 in a direction close to the second unlocking apparatus 730, thereby locking the first unlocking operating portion 712 to the unlock position. Referring to FIG. 47, the first unlocking operating portion 712 is at the unlock position. When the ISOFIX connector 720 abuts against the ISOFIX interface of the vehicle seat, the ISOFIX connector 720 switches to the locked state, and the second connecting member 740 described later pulls the first driving member 713 described later to rotate counterclockwise, thereby driving the first unlocking operating portion 712 to slide to the left. Referring to FIG. 43, the step surface 71251 extrudes the chamfered surface 73101 to the left, causing relative sliding at a contact surface between the two, thereby unlocking the step surface 71251 from the chamfered surface 73101, so that the first unlocking operating portion 712 slides from the unlock position to the lock position and the second unlocking operating portion 7311 slides from the free position to the safe position. A length of the first surface of the first unlocking apparatus 710 perpendicular to the sliding direction thereof is greater than a length of the second surface perpendicular to the sliding direction thereof, or a contact area between the first surface of the third joint portion 7310 and the first surface of the first unlocking apparatus 710 is greater than a contact area between the second surface of the third joint portion 7310 and the second surface of the first unlocking apparatus 710, so that the first unlocking apparatus 710 can be easily driven by the ISOFIX connector 720 to switch to the locked state when locked to the unlocked state. In this embodiment, the first unlocking apparatus 710 is not provided with an elastic member configured to reset the first unlocking operating portion 712 from the unlock position to the lock position, and the first unlocking operating portion 712 is reset by pulling a steel wire, thereby simplifying a structure of the first unlocking apparatus 710. In other embodiments, the first unlocking apparatus 710 may be provided with an elastic member, and the elastic member biases the first unlocking operating portion 712 from the unlock position towards the lock position, thereby making it easier for the first unlocking apparatus 710 to reset to the lock position.

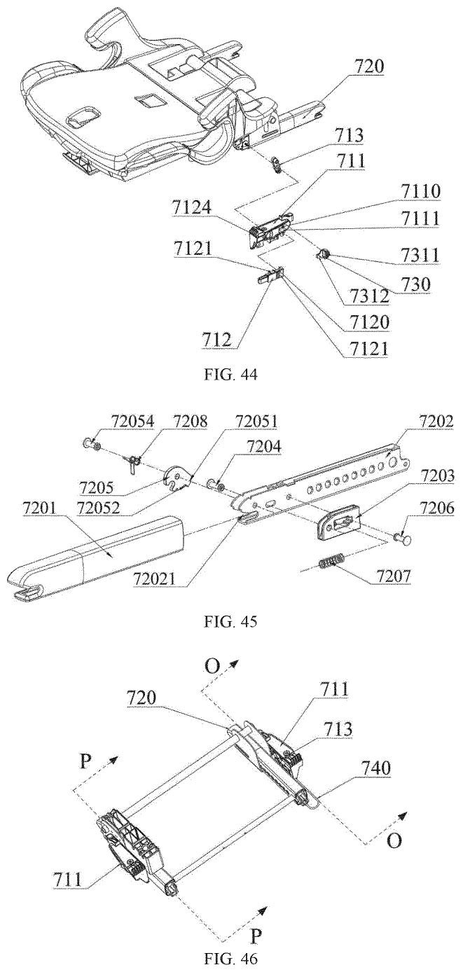

Referring to FIG. 44 to FIG. 47, the first unlocking apparatus 710 further includes a first driving member 713. The first driving member 713 is pivotably arranged on the child safety seat 7. The ISOFIX connector 720 is operably connected to the first unlocking operating portion 712 through the first driving member 713.

Specifically, as shown in FIG. 47, the first driving member 713 includes a pivot shaft 7133 arranged on the child safety seat 7 and a first arm 7131 and a second arm 7132 located on two sides of the pivot shaft 7133. The first arm 7131 is operably connected to the first unlocking operating portion 712, and the second arm 7132 is operably connected to the ISOFIX connector 720. A length of the first arm 7131 is greater than that of the second arm 7132, thereby reducing power required to unlock the ISOFIX connector 720 through the first unlocking operating portion 712.

As shown in FIG. 47 and FIG. 49, the first unlocking operating portion 712 further includes a pivot space 7123. The first arm 7131 is rotatably arranged in the pivot space 7123. Sliding of the first unlocking operating portion 712 can drive the first arm 7131 to rotate around the pivot shaft 7133.

As shown in FIG. 47 to FIG. 50, the ISOFIX safety unlock system 700 further includes a second connecting member 740. One end of the second connecting member 740 is fixedly connected to the second arm 7132, and the other end of the second connecting member 740 is fixedly connected to the ISOFIX connector 720. The second arm 7132 is operably connected to the ISOFIX connector 720 through the second connecting member 740. In this embodiment, the second connecting member 740 is a steel wire, but is not limited thereto, and may alternatively be a connection rod or the like. When the ISOFIX connector 720 switches from the unlocked state to the locked state, the second connecting member 740 can also drive the first unlocking operating portion 712 to slide from the unlock position to the lock position. In addition, the first driving member 713 also functions as a diverter. As shown in FIG. 47, when the first unlocking operating portion 712 moves from the lock position to the unlock position, that is, slides from a left side to a right side in the figure, the first driving member 713 is driven to rotate clockwise. In this case, the second arm 7132 pulls the steel wire 740 from right to left, thereby changing a direction of motion transmission, making an unlock sliding direction of the user more natural. Through the pivot structure of the first driving member 713 and the transmission mode of the steel wire, the first unlocking operating portion 712 may be arranged at a position far away from the ISOFIX connector 720, thereby facilitating the operation of the user.

As shown in FIG. 45, FIG. 48, and FIG. 50, the ISOFIX connector 720 includes a housing 7201, a bracket 7202, a second driving member 7203, a second engaging member 7204, a hook 7205, a limiting member 7206, a sixth elastic member 7207, and a seventh elastic member 7208. The housing 7201 is generally elongated, and the bracket 7202 is arranged inside the housing 7201. A second sliding groove 72021 is defined inside the bracket 7202. The second driving member 7203 is slidably arranged in the second sliding groove 72021. The second driving member 7203 is further operably connected to the first unlocking operating portion 712 through the second connecting member 740 and the first driving member 713. The second engaging member 7204 is fixedly connected to the second driving member 7203. The hook 7205 is pivotably fixed to the bracket 7202 through a pin shaft 72054 and is arranged in the second sliding groove 72021. The hook 7205 can pivot between a connect position and a release position. The limiting member 7206 is fixedly connected to the bracket 7202. One end of the sixth elastic member 7207 is connected to the limiting member 7206, and the other end of the sixth elastic member 7207 is connected to the second driving member 7203. The sixth elastic member 7207 is configured to cause the second driving member 7203 to have a tendency to slide in a direction away from the child safety seat 7. The seventh elastic member 7208 is arranged on the pin shaft 72054 and is configured to cause the hook 7205 to have a tendency to rotate from the connect position to the release position. In this embodiment, the seventh elastic member 7208 is a torsion spring. The hook 7205 has a boss 72051. The boss 72051 has a first surface 72052 abutting against the second engaging member 7204, and the boss 72051 further has a second surface 72053 adjacent to the first surface 72052. The second surface 72053 is configured to contact the second driving member 7203. The second driving member 7203 is provided with a third surface 72032 configured to contact the second surface 72053. The second surface 72053 and the third surface 72032 have approximately same curvature. When the second surface 72053 contacts the third surface 72032, the second surface 72053 can slide relative to the third surface 72032.

An operating process of the above ISOFIX safety unlock system 700 is briefly described below.

As shown in FIG. 47 and FIG. 48, when the ISOFIX connector 720 is in the locked state, the ISOFIX connector 720 can be locked with the IOSFIX interface of the vehicle. In this case, the first unlocking operating portion 712 is at the lock position, and the second unlocking operating portion 7311 is at the safe position. A side wall of the second unlocking operating portion 7311 blocks at least part of the first pressing portion 7121, so that the child cannot easily operate the first pressing portion 7121. As shown in FIG. 35, when the second unlocking operating portion 7311 is at the safe position, part of the first unlocking operating portion 712 enters the limiting space 7312, so that the third joint portion 7310 fits the first joint portion 7120 to lock the first unlocking operating portion 712 to the lock position to prevent the child from operating the first unlocking operating portion 712. In addition, when the ISOFIX connector 720 enters the locked state, the hook 7205 pivots to the connect position, and the second driving member 7203 slides in a direction away from the child safety seat 7 under the action of the sixth elastic member 7207 until the second engaging member 7204 abuts against the hook 7205 and restricts pivoting of the hook 7205, to lock the hook 7205 to the connect position, thereby locking the ISOFIX connector 720 to the locked state.

When the ISOFIX connector 720 is required to be unlocked, the second unlocking operating portion 7311 may be first pressed. When the second unlocking operating portion 7311 is at the free position, the side wall of the second unlocking operating portion 7311 is detached from the first pressing portion 7121, so that the first pressing portion 7121 is exposed, to facilitate the user to operate the first pressing portion 7121 by hand. In this case, the part of the first unlocking operating portion 712 is detached from the limiting space 7312, and the third joint portion 7310 is separated from the first joint portion 7120. That is, the first unlocking operating portion 712 is not locked to the unlock position. When the first pressing portion 7121 is operated to slide from the lock position to the unlock position in a direction away from the second unlocking operating portion 7311, the sliding of the first unlocking operating portion 712 can drive the first arm 7131 of the first driving member 713 to rotate around the pivot shaft 7133, thereby driving the second arm 7132 of the first driving member 713 to pull the second connecting member 740. The second driving member 7203 of the ISOFIX connector 720 is pulled by the second connecting member 740 and slides in the second sliding groove 72021 towards the child safety seat 7, and the second engaging member 7204 is detached from the hook 7205 and no longer restricts the pivoting of the hook 7205. Under the action of the seventh elastic member 7208, the hook 7205 rotates from the connect position to the release position. In this case, the IOSFIX connector 720 is in the unlocked state so as to be separated from the IOSFIX interface of the vehicle.

The ISOFIX safety unlock system 700 in one or more of the above embodiments has some of the following technical effects.
1. After the second unlocking operating portion 7311 is adjusted to the free position, the first unlocking operating portion 712 is slid to the unlock position, which can prevent accidental unlocking of the user or the child.
2. Unlocking directions of the second unlocking operating portion 7311 and the first unlocking operating portion 712 are orthogonal to each other, which can effectively reduce a probability of an accidental touch compared with the design in the known art in which sliding directions of the second unlocking operating portion and the first unlocking operating portion are parallel or on a same straight line.
3. The first unlocking operating portion 712 is locked by the second unlocking operating portion 7311 to both the lock position and the unlock position. The first unlocking operating portion 712 is locked by the second unlocking operating portion 7311 to the lock position, which is intended to prevent accidental unlocking by an accidental touch. The first unlocking operating portion 712 is locked by the second unlocking operating portion 7311 to the unlock position, which is intended to keep the ISOFIX connector 720 in the unlocked state, thereby facilitating the mounting of the child safety seat and simplifying the structure of the ISOFIX system.
4. The color indicator 7122 displays a color indication at the lock position and hides the color indication in the unlocked state to facilitate the user to understand the current locked state of the ISOFIX connector 720.
5. The first driving member 713 enables the unlocking to be completed by sliding the first unlocking operating portion 712 in a direction away from the ISOFIX hook 7205, and the direction is the same as a disassembly direction of the ISOFIX connector, which facilitates the operation.
6. The first driving member 713 may adjust a stroke of the unlocking operating portion by changing a length ratio of the first arm 7131 to the second arm 7132, and a longer stroke may better prevent accidental touches.
7. The first driving member 713 allows the first unlocking operating portion 712 to be arranged at a different height than the ISOFIX connector 720, so as to flexibly arrange the position of the first unlocking operating portion 712 for easy operation.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1. A seat plate adjustment system for a child safety seat, comprising a seat plate and a base, the seat plate being movable between a first position and a second position in a first direction relative to the base,
the seat plate comprising:
a first through hole configured to be thread by a crotch strap,
wherein the base comprises a second through hole configured to be threaded by the crotch strap,
wherein when the seat plate is at the first position, a length of the crotch strap passing through the first through hole is a first length;
when the seat plate is at the second position, a length of the crotch strap passing through the first through hole is a second length, and the first length being less than the second length.

2. The seat plate adjustment system according to claim 1,
wherein the seat plate further comprises a connecting portion restricting movement of the seat plate in a second direction relative to the base the second direction being perpendicular to the first direction;
wherein the connecting portion comprises:
at least one first connecting portion provided on the seat plate; and
at least one second connecting portion provided on the base and fitting the at least one first connecting portion and the seat plate being slidably connected to the base through fitting between the first connecting portion and the second connecting portion.

3. The seat plate adjustment system according to claim 2, wherein
the first connecting portion and the second connecting portion are movably connected in a vertical direction, so that the first adjustment portion unfits the second adjustment portion or the third adjustment portion,
the first connecting portion is a connecting column, the connecting column being fixedly arranged on a side of the seat plate facing the base
the second connecting portion is a first connecting groove, the first connecting groove being arranged on a side of the base facing the seat plate the first connecting groove running through the side of the base facing the seat plate and the first connecting groove extending in a front-rear direction of the base,
the connecting column being inserted into the first connecting groove so as to be capable of sliding back and forth along a length direction of the first connecting groove, and
an end of the connecting column away from the seat plate is provided with a first stopper, the first stopper being detachably fixed to an end of the connecting column away from the seat plate, and the first stopper is sized so as not to pass through the first connecting groove.

4. The seat plate adjustment system according to claim 2, wherein
the seat plate lockably slides between the first position and the second position relative to the base, and a seat length of the child safety seat when the seat plate is at the first position is less than that of the child safety seat when the seat plate is at the second position,
the first connecting portion is a convex strip, the convex strip being fixedly arranged on a side of the seat plate facing the base, and the convex strip extending in a front-rear direction of the seat plate,
the second connecting portion is a second connecting groove, the second connecting groove being arranged on a side of the base facing the seat plate the convex strip being embedded in the second connecting groove.

5-18. (canceled)

19. The seat plate adjustment system according to claim 1, wherein
a gap is formed between a side of a front end of the base facing the seat plate and a side of a front end of the seat plate facing the base, and the gap is adapted to allow the crotch strap to pass through.

20. The seat plate adjustment system according to claim 1, wherein
when the seat plate is at the first position, a projection of the second through hole in a vertical direction does not overlap with a projection of the first through hole in the vertical direction, and
when the seat plate is at the second position, at least part of the projection of the second through hole in the vertical direction overlaps with the projection of the first through hole in the vertical direction.

21. The seat plate adjustment system according to claim 1, wherein the seat plate further comprises an adjustment portion being operable to restrict movement of the seat plate in the first direction relative to the base, and the adjustment portion comprises:
a first adjustment portion provided on the seat plate; and
a second adjustment portion and a third adjustment portion provided on the base,
wherein the first adjustment portion is fitted the second adjustment portion, so that the seat plate is locked to the first position,
the first adjustment portion is fitted the third adjustment portion, so that the seat plate is locked to the second position,
the seat plate lockably slides between the first position and the second position relative to the base, and a seat length of the child safety seat when the seat plate is at the first position is less than that of the child safety seat when the seat plate is at the second position.

22. The seat plate adjustment system according to claim 4, wherein
a first accommodating space is defined inside the seat plate,
the first adjustment portion is at least partially arranged in the first accommodating space, and the first adjustment portion comprises:
an operating member being slidable between a lock position and an adjust position; and
a first engaging member being operably connected to the operating member, the first engaging member being slidable between an extend position and a retract position, and the first engaging member being adapted to be engaged with the second adjustment portion and the third adjustment portion,
when the seat plate is at the first position, the operating member is slid to the lock position, so that the first engaging member slides to the extend position, the first engaging member is engaged with the second adjustment portion, and the seat plate is fixed to the first position; and the operating member is slid to the adjust position, so that the first engaging member slides to the retract position, the first engaging member is disengaged from the second adjustment portion, and the seat plate is unfixed from the first position; and
when the seat plate is at the second position, the operating member is slid to the lock position, so that the first engaging member slides to the extend position, the first engaging member is engaged with the third adjustment portion, and the seat plate is fixed to the second position; and the operating member is slid to the adjust position, so that the first engaging member slides to the retract position, the first engaging member is disengaged from the third adjustment portion, and the seat plate is unfixed from the second position.

23. The seat plate adjustment system according to claim 22, wherein
the operating member is provided with a limiting groove, and the first accommodating space is provided with a limiting convex portion fitting the limiting groove, the limiting groove extending in the front-rear direction of the base,
the fitting between the limiting groove and the limiting convex portion at least defines a first limit position of the operating member, the first limit position corresponding to the lock position of the operating member, and
the fitting between the limiting groove and the limiting convex portion further defines a second limit position of the operating member, the second limit position corresponding to the adjust position of the operating member.

24. The seat plate adjustment system (10) according to claim 21, wherein
the first adjustment portion (202) further comprises a first connecting member (2022), one end of the first connecting member (2022) being fixedly connected to the operating member (2021), another end of the first connecting member (2022) being fixedly connected to the first engaging member (2023), the first connecting member (2022) being a flexible connecting strip, and the first connecting member (2022) being integrated with the operating member (2021).

25. A child safety seat, comprising a base;
a seat plate being movable between a first position and a second position in a first direction relative to the base; and
an adjustment portion being operable to lock the seat plate in the first position or the second position,
wherein the seat plate comprises a first through hole configured to be thread by a crotch strap, and the base comprises a second through hole configured to be threaded by the crotch strap,
when the seat plate is in the first position, the length of the crotch strap through the first through hole has a first length; and when the seat plate is in the second position, the length of the crotch strap through the first through hole has a second length; the first length is less than the second length.

26. The child safety seat according to claim 25, wherein
when the seat plate is in the first position, the child safety seat has a first seat length; and when the seat plate is in the second position, the child safety seat has a second seat length;
wherein the first seat length is less than the second seat length.

27. The child safety seat according to claim 25, wherein
a gap is formed between the base and the seat plate, and the gap is adapted to allow the crotch strap to pass through.

28. The child safety seat according to claim 25, wherein
when the seat plate is at the first position, a projection of the second through hole in a vertical direction does not overlap with a projection of the first through hole in the vertical direction, and
when the seat plate is at the second position, at least part of the projection of the second through hole in the vertical direction overlaps with the projection of the first through hole in the vertical direction.
